(19) United States
(12) Patent Application Publication
(10) Pub. No.: US 2012/0064497 A1
(43) Pub. Date: Mar. 15, 2012

(54) PATIENT RESUSCITATION SIMULATION TRAINING AND PERFORMANCE TRACKING SYSTEM

(76) Inventor: Raymond Bing-ray Wu, Skokie, IL (US)

(21) Appl. No.: 13/086,844

(22) Filed: Apr. 14, 2011

Related U.S. Application Data
(60) Provisional application No. 61/324,095, filed on Apr. 14, 2010.

(51) Int. Cl. G09B 23/28

(52) U.S. Cl. 434/265

(57) ABSTRACT

The method and apparatus disclosed herein are directed to patient resuscitation simulation training and performance tracking. The disclosed method and apparatus includes a high-fidelity simulator with a real-time engine that can simulate real life situations and conditions for training and testing. The simulator also uses an infinitely-variable constraint-based real-time engine to eliminate the issue of “script memorization” by making each case random and/or unique. The simulator can also train users to recognize the characteristics of properly executed resuscitation interventions such as chest compressions and oxygen mask bagging techniques.

### TECHNICAL FIELD

The present application relates in general to providing medical instructions, and specifically to training and tracking users' resuscitation skills.

### BACKGROUND

Well-executed resuscitation requires a coordinated team effort from multiple disciplines, led by an effective resuscitation team leader. Resuscitation providers need to learn skills such as Advanced Cardiovascular Life Support (ACLS), Pediatric Advanced Life Support (PALS), and other protocols. Traditional training methods do not effectively maintain resuscitation skills, establish consistency between various disciplines and training centers, teach resuscitation team leadership and team dynamics, or track ongoing competency. They are also inefficient in broadcasting changes to the resuscitation protocols which occur periodically. Physical simulation labs are gaining popularity but they suffer from multiple critical issues including extremely high costs, geographic and time limitation of resources, and varying simulation quality. Becoming skilled at resuscitation requires repetition. Traditional training methods and physical simulation labs are neither efficient nor cost-effective methods of providing the necessary amount and quality of practice.

Software solutions are better able to fit this need but currently available computer-based simulators have several drawbacks. They do not provide realistic simulation experiences, have minimal focus on resuscitation team management and intervention quality, and suffer from low re-use value due to having a limited number of scenarios. They do not replicate the logistical issues often encountered in resuscitation events. They also do not present information consistent with real-life resuscitation events. For example, current simulators provide an initial case briefing with detailed patient history information. By contrast, in most real-life situations, patient history information is often obtained sporadically as the resuscitation scenario evolves. Providing too much patient history information in the initial case briefing can result in the undesired effect of “script memorization” where users can memorize the script and regurgitate the memorized script based on cues in the case briefing. “Script memorization” reduces the efficacy of training on these kinds of simulators because the user is merely learning to memorize a pre-planned course of actions specific to that case, instead of reacting and adapting to a situation and utilizing the user's understanding of the resuscitation protocols to stabilize the situation. Furthermore, current software solutions do not have a way to train users to recognize performance of interventions such as proper chest compression and bag-valve mask ventilation techniques.

### SUMMARY

The network-based approach of the present invention, by using Rich Internet Application and other technologies, addresses these issues by providing consistent high-fidelity team-management oriented resuscitation simulation training anywhere and anytime to users across various disciplines in a highly-scalable and cost-effective manner; facilitating centralized storage of simulation performance data; enabling users and supervisors to easily review simulation performance history and track ongoing simulation competency; facilitating rapid distribution of updates to protocols and program improvements; and providing a way to enable users to train to excellence rapidly and efficiently. As a high-fidelity simulator, the present invention replicates the logistical issues encountered in real-life resuscitation events. The simulator also uses an infinitely-variable constraint-based real-time engine to eliminate the issue of “script memorization” by making each case random and/or unique. The simulator can also train users to recognize the characteristics of properly executed resuscitation interventions such as chest compressions and bag-valve mask ventilation techniques.

The present invention generally provides a collection of integrated programs that form a system designed to accelerate and improve the quality of Advanced Cardiovascular Life Support (ACLS) or other patient resuscitation training for healthcare professionals.

An embodiment of the present invention provides a software program including an infinitely-variable constraint-based real-time computerized patient resuscitation simulator that is able to simulate the intra-patient and extra-patient states and conditions often encountered during patient resuscitation. The simulator is able to simulate changes in these states continuously, at the resolution of the frame rate of the simulator (e.g., fractions of a second). In one embodiment, interactions and interventions with the patient are performed either directly by the user and/or via assistants on the screen that the user can direct. These assistants can be controlled independently of one another and can also act concurrently (in parallel). All interactions and interventions take into account the passage of time and relevant actions/inactions performed by assistants and associated effects are produced based on them. Using a constraint-based system, the simulator is able to produce an infinite number of unique cases in which the user is able to explore any combination and/or sequence of actions in a non-linear manner. In one embodiment, the user's actions are constantly monitored and evaluated by the simulator and at the end of a simulation case, a summary of the user's performance is presented to the user. The different subcomponents of the simulator itself can be processed either synchronously (e.g. fixed sequence in a single processing thread in one computer) or asynchronously (e.g. non-fixed sequence with each component on a separate processing thread whether on one computer or on several computers connected via a network or Internet).

In one embodiment, the system also includes performance data review modules that allow users to review their performance data collected by the simulator. These modules enable individual users and managers of groups of users to track performance on a case-by-case basis as well as trends over periods of time, and to track ongoing simulation competency for certification or other purposes. In one embodiment, these modules can also provide a way to generate certification codes which can serve the purpose of confirming the satisfactory completion of a selected number of cases by the user within a particular time frame.

The components of the system are delivered and received through a network from a server or set of servers to which the components send and receive information. The server can also verify the authenticity and strength of the certification codes that are generated for qualified users.

### BRIEF DESCRIPTION OF THE FIGURES

FIG. 1 illustrates an example of the interactions between components of the system.

FIG. 2 illustrates an example screenshot of a “main menu” interface.

FIG. 3 illustrates an example screenshot of an interface for selecting a initial patient rhythm.

FIG. 4 illustrates an example screenshot of a layout of a simulator interface during a simulation.

FIG. 5 illustrates an example of interactions and flow of information between various components in a simulator.

FIG. 6 illustrates an example of a general flow of a simulator program.

FIG. 7 illustrates an example of a processing flow for simulator components during a simulation.

FIG. 8 illustrates an example screenshot of how to check a patient's pulse.

FIG. 9 illustrates an example screenshot of how to assess a patient.

FIG. 10 illustrates an example screenshot of measuring vital signs.

FIG. 11 illustrates an example screenshot of a defibrillator and defibrillation.

FIG. 12 illustrates an example screenshot of a time delay in a laboratory processing of a blood sample drawn from the patient.

FIG. 13 illustrates an example screenshot of a “Help” tab.

FIG. 14 illustrates an example screenshot of an “ACLS Cards” panel.

FIG. 15 illustrates another example screenshot of an “ACLS Cards” panel.

FIG. 16 illustrates another example screenshot of an “ACLS Cards” panel.

FIG. 17 illustrates an example screenshot of an assistant walking to a point the user selected.

FIG. 18 illustrates an example screenshot of options in a Compression Submenu.

FIG. 19 illustrates an example screenshot of options in an Oxygen Support Submenu.

FIG. 20 illustrates an example screenshot of bagging options.

FIG. 21 illustrates an example screenshot of an Attach Monitors Submenu options.

FIG. 22 illustrates an example screenshot of an Give Medications Submenu options.

FIG. 23 illustrates an example screenshot of a medication subpanel with dosage and administration route options.

FIG. 24 illustrates an example screenshot of a Draw Labs Submenu options.

FIG. 25 illustrates an example screenshot of speech bubbles.

FIG. 26 illustrates an example screenshot of an Assistant Selection panel.

FIG. 27 illustrates an example screenshot of a page from a Tutorial Mode.

FIG. 28 illustrates an example screenshot of a grade breakdown on a Case Debriefing Panel.

FIG. 29 illustrates an example screenshot of a case overview on a Case Debriefing Panel.

FIG. 30 illustrates an example screenshot of a “tracings” display which can depict tracings of an ECG and of chest compressions waveforms performed during a simulation, and other data.

FIG. 31 illustrates an example screenshot of an Overview Panel from a Performance Data Review Module for Users.

FIG. 32 illustrates an example screenshot of a Certification panel from a Performance Data Review Module for Users.

FIG. 33 illustrates an example screenshot of a Certification panel from a Performance Data Review Module for Users showing a magnified view of a certification card.

FIG. 34 illustrates an example screenshot of a Case Details panel from a Performance Data Review Module for Users showing a grade breakdown from a case.

FIG. 35 illustrates an example screenshot of a Case Details panel from a Performance Data Review Module for Users showing a case event log from a case.

FIG. 36 illustrates an example screenshot of an Overview Panel from a Performance Data Review Module for Managers.

FIG. 37 illustrates an example screenshot of a Certification panel from a Performance Data Review Module for Managers.

FIG. 38 illustrates an example screenshot of a Case Details panel from a Performance Data Review Module for Managers showing a grade breakdown from a case.

FIG. 39 illustrates an example screenshot of a quantitiative capnography tracing and an end-tidal carbon dioxide partial pressure reading.

FIG. 40 illustrates another example screenshot of Attach Monitors Submenu options.

FIG. 41 illustrates an example screenshot of a “tracings” display which also depicts quantitative capnography tracings from a simulation.

FIG. 42 illustrates an example screenshot of a 12-lead ECG display panel showing a 12-lead ECG being recorded.

FIG. 43 illustrates an example screenshot of a previously recorded 12-lead ECG being displayed.

FIG. 44 illustrates another example screenshot of an Overview Panel from a Performance Data Review Module for Users showing a Performance History Index and Graph.

FIG. 45 illustrates a high level block diagram of an exemplary network communications system.

FIG. 46 illustrates a more detailed block diagram of the electrical systems of a computing device.

### DETAILED DESCRIPTION

In one embodiment, an embodiment of the present invention provides a training and review system consisting of four components:

Infinitely variable constraint-based real-time simulator

Performance Data Review Module for Users

Performance Data Review Module for Managers

Website/Server-interface

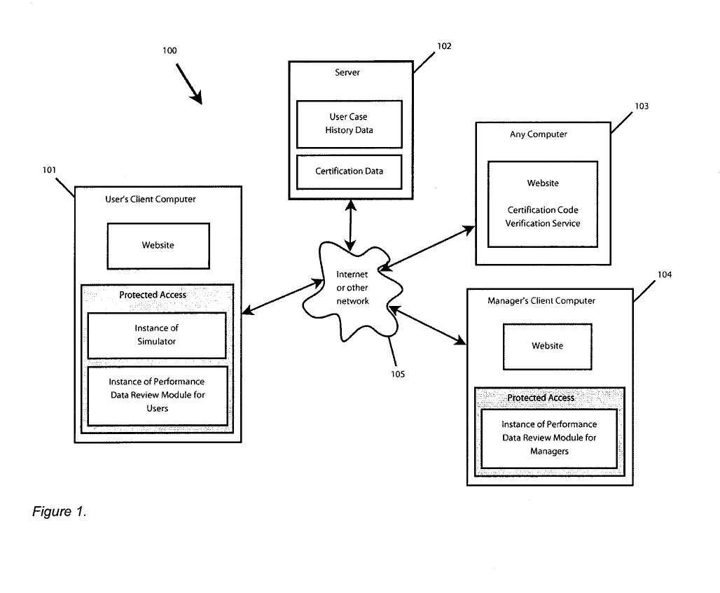

Referring to FIG. 1, a real-time simulator and performance data review modules are linked to each other and delivered to end-users through a website/server-interface so that data can be processed, passed between the simulator and modules and stored in a centralized resource.

Infinitely Variable Constraint-Based Real-Time Simulator

The system includes a real-time simulator that provides a fully-interactive graphical simulation environment. This environment can include sound and animated photorealistic images representing a patient(s), assistant(s), and equipment, all controllable in parallel and in real-time by the user. Innovative user interfaces can be used to replicate the uncertainties of real-life code scenarios (e.g. pulse checks, personnel movement, etc.). To elevate the level of simulation realism, a model of the patient's physiology and a model of the environmental simulation can be calculated continuously, asynchronously, and in real-time. In one embodiment, user performance metrics are continuously monitored and recorded, which can then be displayed to the user during automatic debriefings at the end of each case. These metrics and recordings can include, but are not limited to, measures such as compression fraction, time-to-defibrillation, chest compression tracings, quantitative capnography, and electrocardiogram (ECG) tracings.

FIG. 1 illustrates an example of how components of the system interact with each other. Block 101 represents a user intending to use the system's training features interacting with the system through a computer or similar device. Besides presenting a website to the user, components of the system such as the simulator and Performance Data Review Module for Users may also be presented, usually but not necessarily through a restricted access mechanism.

Block 102 represents a computer or a similar device, or a group of computers or similar devices which would serve website, user and other data, and other components of the system through the network 105 as appropriate. Block 102 may also serve as a repository for data acquired from the instances of the components which are in use.

Block 103 represents a user intending to use the system's Certification Code verification services interacting with the system through a computer or similar device. This service may be generally accessible by any person but can also be put behind restricted access protection.

Block 104 represents a user intending to use the system's management features interacting with the system through a computer or similar device. Besides presenting a website to the user, elements of the system such as the Performance Data Review Module for Managers can be also be presented, usually but not necessarily through a restricted access mechanism.

Network 105, whether an external network such as the Internet or something similar, or an internal network such as a local area network, provides a way for the various components of the system to communicate with each other. These components are usually, but do not necessarily need to be, running on separate computing devices.

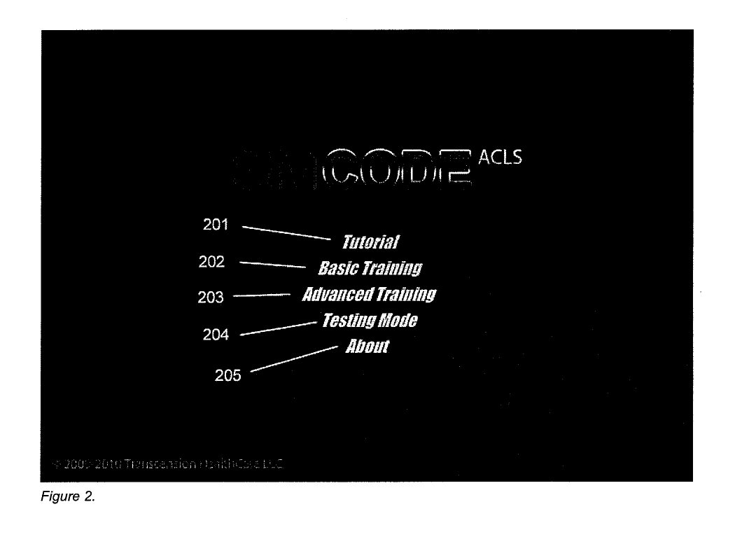

Referring to FIG. 2, the simulator contains a “main menu” interface through which the user chooses one of several modes that can include, for example, tutorial, basic training, advanced training, and testing modes. FIG. 2 illustrates an example screenshot of a “main menu” interface. Item 201 is an example of a control for a “Tutorial” option. Item 202 is an example of a control for a “Basic Training” option. Item 203 is an example of a control for an “Advanced Training” option. Item 204 is an example of a control for a “Testing” option. Item 205 is an example of a control for an “About” option.

The Tutorial mode is an interactive guide on how to use the various components and features of the simulator. It can also provide additional information such as the steps for performing ACLS during a resuscitation event.

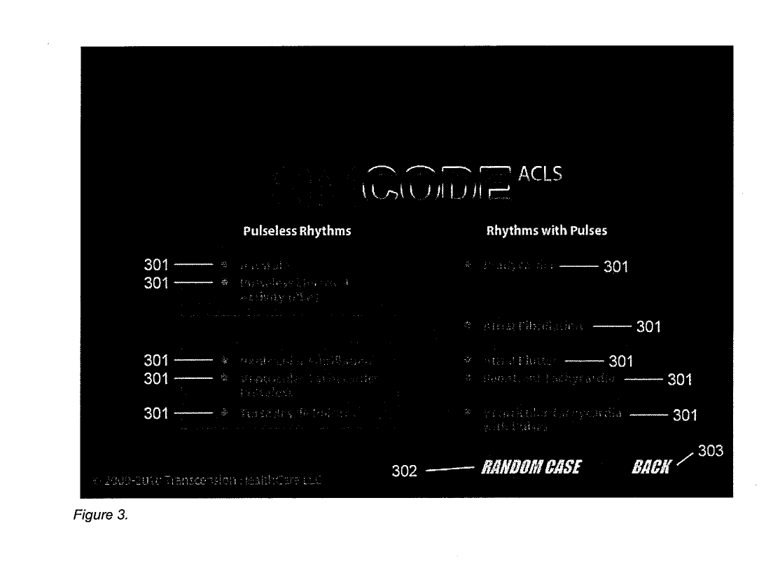

The basic training mode provides the user with assistants who are “perfect” in that they always successfully complete procedures and perform interventions properly. As illustrated in FIG. 3, the user in one embodiment can select an initial patient rhythm, or alternatively have the computer select one in a pseudo-random manner which, over many simulations, can provide an even distribution of initial patient rhythms. The user also can have access to intra-simulation aids (e.g., ACLS protocol cards, context sensitive hints) in this mode.

The advanced training mode adds “environmental” effects such as imperfect assistants. For example, assistants may perform chest compressions at the incorrect rate or depth or they may get fatigued. Other examples include failed attempts at interventions such as establishing intravenous (IV) access or endotracheal (ET) intubation. As illustrated in FIG. 3, the user can select an initial patient rhythm or have the simulator select one in a pseudo-random manner which, over many simulations, can provide an even distribution of initial patient rhythms. The user also can have access to intra-simulation aids (e.g., ACLS protocol cards, context sensitive hints) in this mode.

The testing mode is similar to the advanced training mode but the user does not have access to the intra-simulation training aids. In one embodiment, cases passed successfully in the testing mode may be counted towards certification credits. Cases may be randomly chosen by the simulator from a set of less frequently passed initial patient rhythms, thus allowing the user to experience a variety of initial patient rhythms in a more evenly distributed manner. The grading system can be adjusted to promote closer adherence to ACLS protocol guidelines or some other guidelines in order to pass a case.

FIG. 3 is an example screenshot of the interface for selecting the initial patient rhythm. Items 301 are examples of controls the user can activate to select a simulation scenario with a particular initial patient rhythm type. In this screenshot, the layout of the controls is organized by similarities of the patient rhythms as well treatment patterns. For example, the pulseless rhythms are on the left side of the screen while the rhythms with pulses are on the right side of the screen. In addition, rhythms which are treated in similar ways are grouped together as indicated in this example by the boxes in the background and the spacing. The organized layout can make it easier for users to remember the details of each patient rhythm type and the proper treatment protocols for each.

Item 302 is an example of a control which the user can activate to have the computer pick out a simulation case for the user. Item 303 is an example of a control to return the user to the previous screen.

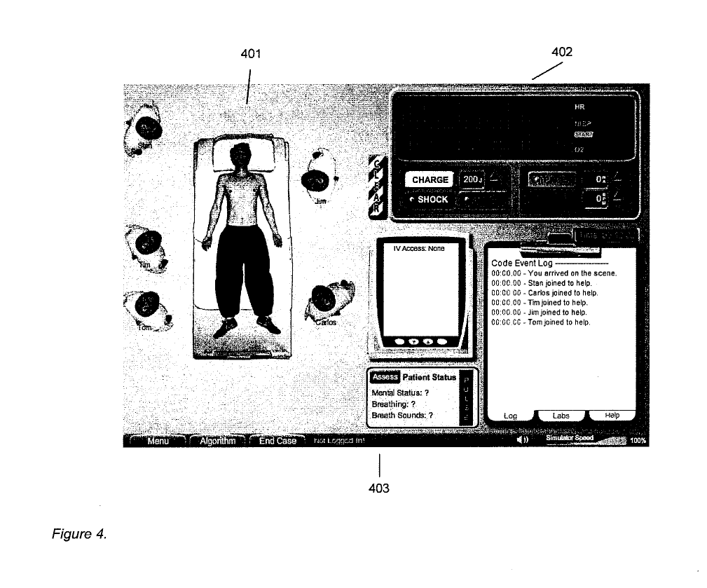

FIG. 4 is an example screenshot of a layout of a simulator interface during simulation. The simulation interface screen consists of several interface components which allow the user to interact with the simulator. In one example, there is a “personnel interaction” area 401 in which assistants and the patient are located, and where the assistants can move around. FIG. 4 also illustrates an example “equipment/data interaction” area 402 where virtual equipment and data display interfaces are visible. Item 403 illustrates an example of a “taskbar” interface in the simulation screen.

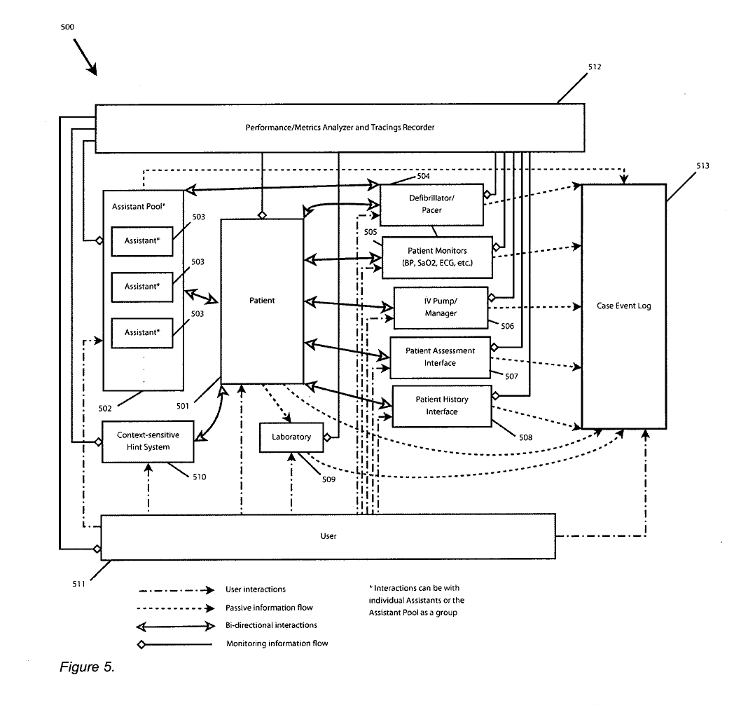

FIG. 5 illustrates a diagram of how various components of the simulator interact and how data generally flows between them. Some components may be passive information receivers while others may be “monitoring” components that constantly query other components and record information about them. In one embodiment, the user can interact with all of the components except for the “Performance/Metrics Analyzer and Case Tracing Recorder,” which is constantly monitoring other components and the user.

Patient

Block 501 represents a computer model of the patient, which generally includes but is not limited to associated user interfaces, parameters, data, and subroutines. This model is responsible for accepting any external inputs from other models and objects in the simulator, and updating the internal model of the patient appropriately. It can also send notifications and data to the other models and objects in the simulator. A user 511 can also interact with the patient model through certain interfaces.

Assistant Pool

Block 502 represents a computer model of a pool of assistants available in the simulation and generally includes but is not limited to associated parameters, data, and subroutines. It is responsible for maintaining an organized representation of the assistants and the states of their actions as a collective. It also assists with the communications between the different instances of the assistants 503. It can send and receive notifications to the patient model 501 as well as other objects including, but not limited to, a Defibrillator/Pacer 504.

Assistants

Block 503 represents a computer model of the instances of the assistants in the simulation and generally includes but is not limited to associated user interfaces, parameters, data, and subroutines. In one embodiment, each assistant may be unique and can be directly interacted with by the user 511 but is also part of the Assistant Pool 502 which helps organize the assistants and provide a collective artificial intelligence in addition to the individual artificial intelligence for each assistant instance. The assistants can interact directly with the patient model(s) 501 as well as other objects if needed.

Defibrillator/Pacer

Block 504 represents a computer model of an instance of the Defibrillator/Pacer virtual device and generally includes but is not limited to associated user interfaces, parameters, data, and subroutines. It is responsible for maintaining and updating the states of the device as appropriate. It can receive input from the user 511 and other objects in the simulation such as, but not limited to, the patient monitors and the patient. It can monitor certain aspects of the patient model(s) 501 and can also send out signals to the patient model(s) 501 to indicate certain interventions such as electrical shocks.

Patient Monitors

Block 505 represents computer models of instances of various Patient Monitor virtual devices including but not limited to blood pressure, pulse oximetry, electrocardiogram, end-tidal carbon dioxide partial pressure, and quantitative capnogrpahy. These models generally include, but are not limited to the user interface, parameters, data, and subroutines associated with each virtual device. Each model may be responsible for maintaining and updating the state of the device as appropriate. They can monitor certain aspects of the patient model(s) 501 and can also send out signals to other objects in the simulation as necessary. They can also receive input from the user 511 and other objects in the simulation.

IV Pump/Manager

Block 506 represents a computer model of an instance of the IV Pump/Manager virtual device and generally includes but is not limited to associated user interfaces, parameters, data and subroutines. In one embodiment, this virtual device organizes the intravenous lines which are connected to the patient model(s) 501 as well as the medications which are being pumped, or are going to be pumped, through the device into the patient model(s) 501. It is responsible for maintaining and updating the state of the device as appropriate and can receive input from the user 511 as well as other objects in the simulation including the patient model(s) 501. It can send signals to the patient model(s) 501 to indicate events such as medications being infused. It can also send signals to other objects in the simulation as needed.

Patient Assessment Interface

Block 507 represents an interface that the user 511 can use, but is not necessarily required to use, to assess the various aspects of the patient model(s) 501. These aspects include but are not limited to mental status, breathing sounds, respiratory pattern, and other components of a medical physical examination. It interacts with the patient model(s) 501 and is capable of sending and receiving information from and to it.

Patient History Interface

Block 508 represents an interface that the user 511 can use, but is not necessarily required to use, to obtain information about the patient model 501 medical history. This information can include, but is not limited to, histories of past medical events, medications, physical exams, and other information typically found in patient medical histories. It interacts with the patient model(s) 501 and is capable of sending and receiving information to and from the patient model.

Laboratory

Block 509 represents a computer model of an instance of a virtual laboratory and generally includes but is not limited to associated user interfaces, parameters, data, and subroutines. It is responsible for processing the blood samples retrieved from the patient model(s) 501 at any particular point in time by any instance of an assistant 503. It organizes the resulting laboratory data so that the user can review them at any subsequent point in time. It generally receives data from the patient model 501. The user 511 can interact with the virtual laboratory.

Context-Sensitive Hint System

Block 510 represents a Context-sensitive Hint System which generally includes, but is not limited to associated user interfaces, parameters, data, and subroutines. In certain simulation settings, it is responsible for generating and providing relevant hints for the user. In other settings, it can also provide immediate feedback on the user's actions and performance. It can interact with the patient model(s) 501 and the Performance/Metrics Analyzer and Tracings Recorder 512 as well as other objects in the simulation as needed.

User

Block 511 represents the user. While the user is usually a human, it can also be another computer such as an artificial intelligence device. One example of a situation that this would be used is in providing computer guided tutorials or demonstrations, for instructional or other purposes.

Performance/Metrics Analyzer and Tracings Recorder

Block 512 represents the Performance/Metrics Analyzer and Tracings Recorder which generally includes but is not limited to associated user interfaces, parameters, data, and subroutines. In one embodiment, it is responsible for monitoring all of the other objects in the simulation including the user 511 and analyzing the performance characteristics and metrics of the evolving simulation. In addition, it records a copy of all the tracings generated during the simulation. The results of the analysis and the recordings can be presented to the user either continuously as the simulation is evolving or at the end in a debriefing type setting.

Case Event Log

Block 513 represents the Case Event Log which is a virtual device that keeps a record of all the events in that have transpired in the simulation. It generally includes, but is not limited to associated user interfaces, parameters, data, and subroutines. This virtual device can be mostly passive whereby it receives notifications about transpired events from the other objects in the simulation. However, it can record events actively by monitoring the other objects in the simulation. The user 511 can interact with this virtual device to review the events that have already transpired in the simulation in various levels of detail.

General Program Flow Diagram

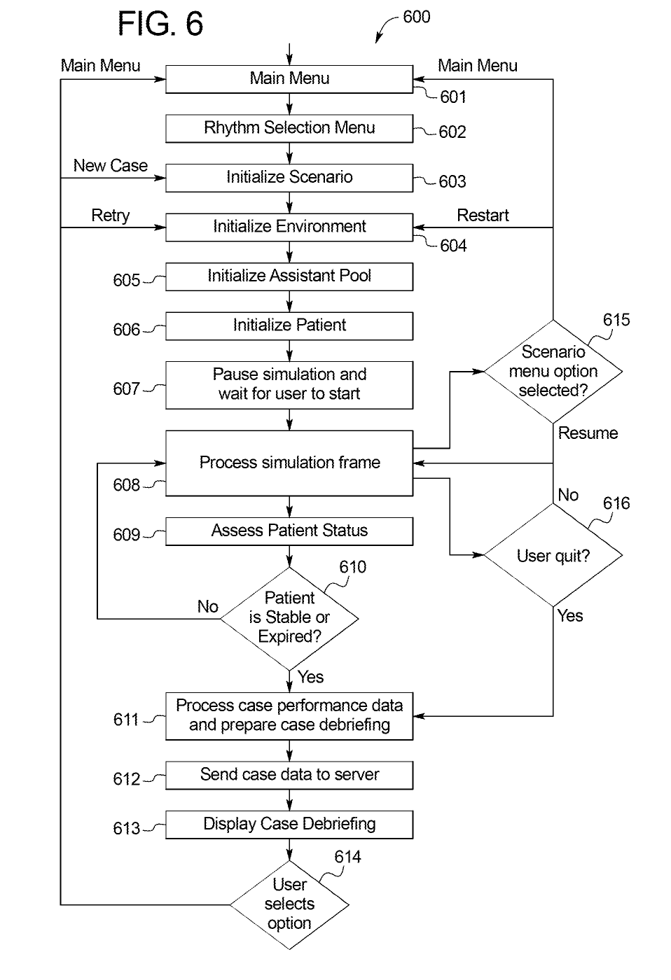

FIG. 6 illustrates an example of a general flow of a simulation program. The process 600 is embodied in one or more software programs which is stored in one or more memories and executed by one or more processors. Although the process 600 is described with reference to FIG. 6, it will be appreciated that many other methods of performing the acts associated with process 600 may be used. For example, the order of many of the steps may be changed, and many of the steps described may be optional.

Referring to FIG. 6, at the beginning of a simulation case, the simulator is initialized based on the simulation mode and initial patient rhythm selected by the user and/or computer through the main menu and rhythm selection menu, respectively. The initialization process includes initializing the environmental simulation model and the patient's physiology model. In one embodiment, the environmental simulation model variables are chosen at random within a range of constraints to fit the parameters of the selected simulation mode. These variables include, but are not limited to, the procedure success rates (e.g. how often an IV access point can be established) and inherent intervention performance characteristics (e.g. chest compression rate and depth, endurance) of the assistants. The patient's physiology model variables are initialized to random values which lie within pre-determined constraints so that the behavior of the model correlates with the behavior of human physiology as it applies to ACLS. These variables include, but are not limited to, aspects such as blood perfusion, oxygenation, medication distribution pools, and pulse. The use of random values within a constrained space enables the simulator to deliver a virtually unlimited number of unique cases. In one embodiment, there are not constraints for the environmental simulation model variables or for the physiological model.

The process 600 generally begins at block 601 when the software is initialized and displays to the user introductory screens, one of which would be a menu of options which could be similar to the example screenshot of FIG. 2. During the initialization process, relevant user data can be retrieved from the server to customize the process 600 to the user's experience and usage history. When initialization is complete and a menu of options is presented the user, the user will generally have the options to choose one of several simulation modes, including but not limited to a Tutorial mode, Basic Training Mode, Advanced Training Mode, or Testing Mode. In one embodiment, the user may have options to access additional functionality such as but not limited to references, non-simulation-based assessments, and simulator settings. Upon selection of one of any of these options, either the appropriate information will be displayed or a subsequent Rhythm Selection Menu, such as illustrated in screenshot FIG. 3, will be displayed.

After the user has selected one of the simulation modes on the previous menu, the process 600 can present a Rhythm Selection Menu to the user at block 602. This option on the menu can include various initial patient rhythms that the simulator can use at the start of the simulation. In one embodiment, there may be a “random” option in which the process 600 will choose an initial patient rhythm for the user in a pseudo-random manner, either with or without consideration of the user's previous simulation history. In one embodiment, the initial patient rhythm may be completely random. An example of a Rhythm Selection Menu is illustrated in screenshot FIG. 3.

After an initial patient rhythm is selected either by the user or by the computer in block 602, process 600 initializes the simulation environment as appropriate for the selected initial patient rhythm. The initialization routines can include but are not limited to preparing the patient model(s) as illustrated in block 606, user interfaces, graphics, sound, animation, environmental model(s) as illustrated in block 604, the assistant instances and the Assistant Pool as illustrated in block 605 and all other objects in the simulator represented by block 603. The models and objects initialized in these routines are preferably initialized separately so that one can be changed without affecting the other. In one embodiment, changing one routine or models or objects in one routine has an affect on the other routines, such as, for example, the settings used for the models or objects. The example flowchart of FIG. 6 illustrates a certain initialization sequence from blocks 603 to 606 but they can be performed in other orders as well, and some of the blocks may be optional.

Block 603 represents initialization subroutines for objects and models in the simulator that are not related to the patient, the assistant pool, the assistant instances and the environment external to the patient.

Block 604 represents the initialization routines related to the environmental model(s).

Block 605 represents the initialization routines related to the instances of the assistants and the assistant pool.

Block 606 represents the initialization routines related to the patient model(s).

At block 607, the simulation scenario is completely initialized and is paused. A prompt which can display information about the scenario is displayed to the user. A control, such as a button, is also presented to the user which when activated, removes the prompt and unpauses the simulation and proceeds to block 608.

In block 608, process 600 updates all of the objects and models in the simulation as appropriately based on the interactions between the objects and models, as well as any input from the user. In one embodiment, updates can be, but do not necessarily have to be, calculated based on the measured change in time from the previous update. Doing so can make the simulation run at the same speed as time in real-life regardless of the refresh or frame rate of the simulation. Also, during block 608, the user may have access to an intra-simulation menu 615 via a control. Activation of this control will pause the simulation and can present a display to the user which will provide a set of choices as described in block 615. In addition, the user may have access to another control at block 616 which can present the user with a display with the option to return to the simulation or to end the simulation prematurely and show the simulation debriefing. Decision block 616 is described in more detail below.

When at least the patient model update is complete in block 608, process 600 will make the necessary calculations to check if the patient is considered to be in stable condition for a sufficient period of time or not, or has expired by assessing patient status in block 609. Based on this evaluation, the appropriate branch point will be taken in block 610 below. The patient is considered to be stable if certain conditions are met, such as but not necessarily limited to or always requiring vital signs, heart rhythm, mental status, treatment of certain conditions, and/or performance of certain actions. Process 600 evaluates these conditions to make sure they are met continuously, or relatively continuously as appropriate for the condition, over a period of time before taking the appropriate branch point from block 610. In one embodiment, the evaluation may be performed after the first patient model update. In one embodiment, the system may wait a predetermined amount of time or patient model updates. This allows it to take into consideration partially “stable” conditions or situations which can deteriorate into an “unstable” condition. The patient is considered to be expired if certain physiological parameters are met. In one embodiment, the user may have to determine whether the patient is stable. Thus, part of the training and testing includes whether the patient status has been evaluated correctly. In one embodiment, the simulation may cycle in a loop until the user determines the status of the patient.

At block 610, if the patient is not considered to be stable for the required period of time, or is not expired, process 600 returns to block 608 to perform more updates. Otherwise, the simulation scenario is considered complete and process 600 proceeds to block 611.

In block 611, data collected during the simulation is processed and analyzed and a debriefing is generated.

In block 612, the data that was processed and analyzed in block 611 is then sent to the server for storage and future use. In one embodiment, the data is analyzed by a computer. In one embodiment, the data is analyzed by a human such as the user or a manager.

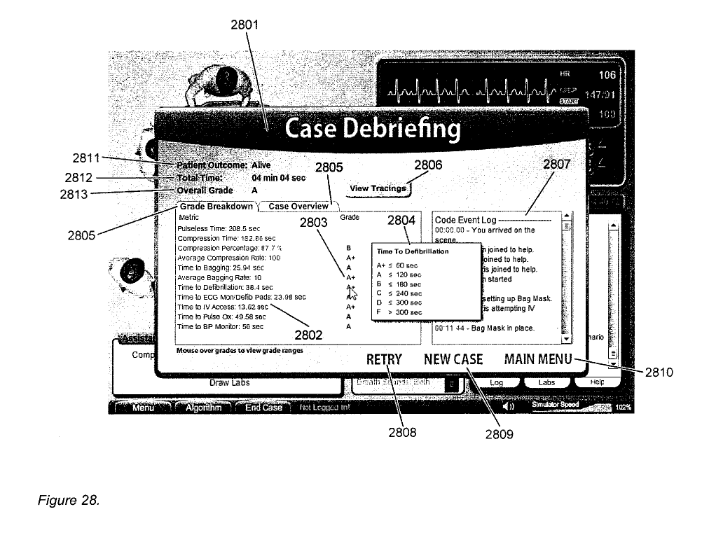

In block 613, process 600 can display the data and results of the analysis from block 611 to the user in a debriefing display, such as illustrated in screenshots FIGS. 28, 29, and 30. This debriefing display can contain various levels of detail and the ability for the user to interact with the data to facilitate the user's reflection on the simulation experience. In one embodiment, along with debriefing display, several controls can be presented to the user which would allow several options including but not limited to retrying the same scenario, starting a new scenario in the same initial rhythm type category, or returning to the main menu. In one embodiment, the user can add notes or comments that are then stored on the server. When the user selects an option by activating a control, process 600 moves to decision block 614 and directs process flow appropriately as described below.

Depending on the option selected by the user in block 614, process 600 may be directed to the appropriate block in this flow diagram. For example, if the user selects to retry the case, process 600 is redirected to block 604 to reset the scenario. If the user selects to try a new case in the same initial patient rhythm category, process 600 is directed to block 603 to generate a new scenario. If the user selects to return to the main menu, process 600 is directed to block 601. If other options are available and selected by the user, process 600 is directed to the appropriate portion of the flow diagram.

In one embodiment, the user can activate a control which will pause the simulation and display a set of controls to the user allowing the selection of options. After the user has made a selection via a control, process 600 moves to block 615 which redirects the flow to the appropriate location. An example of such an option is one to resume the simulation, which would unpause the simulation and redirect process 600 back to block 608. Another example is an option to restart the scenario which then redirects process 600 to block 604. Another example is an option to return to the main menu which redirects process 600 to block 601.

In one embodiment, the user can activate a control at block 616 which can display options to return to the simulation or to end the simulation prematurely and show the simulation debriefing. Block 616 then redirects process 600 appropriately depending on the user's selection. For example, if the user selects the option to return to simulation, process 600 is directed back to block 608. If the user selects to end the simulation prematurely and view the debriefing, process 600 is directed to block 611.

Simulation Frame Processing Flow Diagram

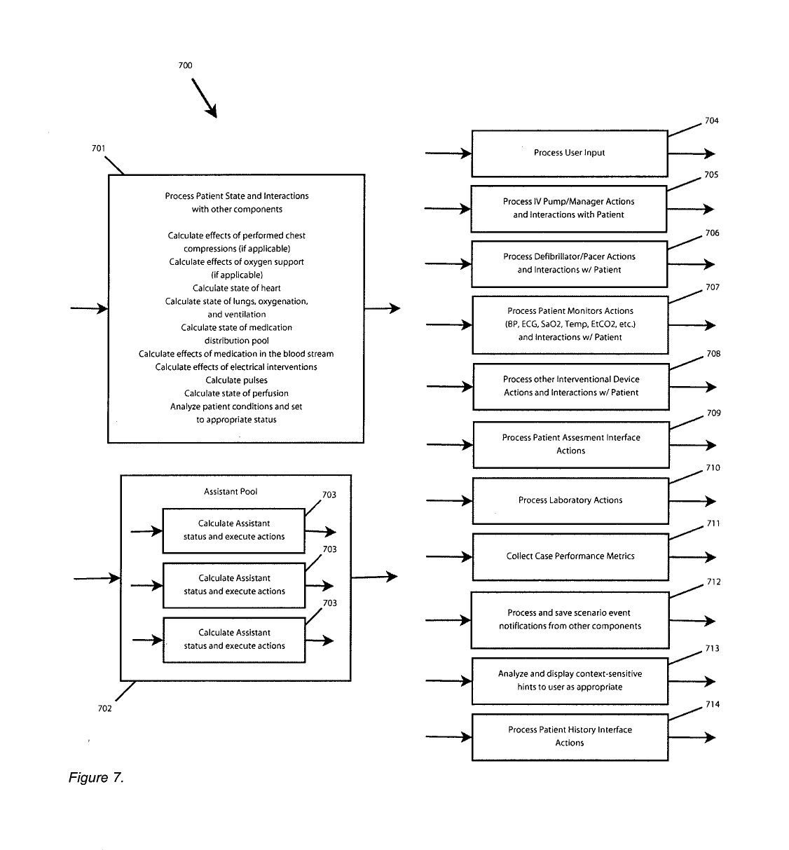

FIG. 7 illustrates an example of subprocesses which may occur during execution of block 608 of process 600. Each subprocess may be processed synchronously or asynchronously and on one or several processing units. Referring to FIG. 7, once the simulation begins, the environmental simulation and patient physiology models are continuously recalculated during each frame of the simulation. In one embodiment, the environmental simulation and patient physiology models are recalculated at a predetermined time interval, or after specified events. These calculations include the progression of each model, the interactions between the models, and the effects the models have on each other, thus allowing for a high degree of simulation resolution. In one embodiment, the user can specify a degree of simulation resolution to vary the effects the models have on each other. The calculations may be based on the timing of the user's actions (or lack thereof) into the simulation, thus changing the details of the simulation at a very fine level.

In block 701, the state of the patient model(s) is updated to reflect any changes from internal interactions or external interactions with the other objects and models in the simulation. The interactions that can be accounted for include, but are not limited to, events such as performed chest compressions, oxygen support, pharmacokinetics and pharmacological effects of medications. The states which can be updated include, but are not limited to, the state of patient's organs and physiology and presence or absence of physical findings. Examples of the physical findings include, but are not limited to pulses, breathing, breathing sounds, and mental status.

In block 702, the state of the assistant pool is updated to reflect any changes from the actions of the member assistant instances in addition to all of the other objects and models in the simulation, including the user. The collective artificial intelligence of the assistant instances can also be updated here as well.

In block 703, the state of each assistant instance is updated to reflect any changes from the actions of the assistant instance as well as all of the other objects and models in the simulation, including the user. The artificial intelligence of each assistant instance can be updated here as well.

In block 704, the user's inputs are processed and any necessary notifications to other objects and models in the simulation can be sent as well.

In block 705, the state of the IV Pump/Manager is updated. Any interactions with the patient model(s) such as, but not limited to, infusion of medications and changes in IV access status can be processed here. In addition, any interactions with all of the other objects and models in the simulation can be processed here as well.

In block 706, the state of the Defibrillator/Pacer is updated. Any interactions with the patient model(s) such as, but not limited to electrical interventions and monitoring of the patient model(s) can be processed here. In addition, any interactions with all of the other objects and models in the simulation can be processed here as well.

In block 707, the state of the patient monitors is updated. Any interactions with the patient model(s) such as, but not limited to, attaching or detaching to the patient and monitoring the patient model(s) can be processed here. In addition, any interactions with all of the other objects and models in the simulation, including the user, can be processed here as well.

In block 708, the state of any other devices is updated. Any interactions with the patient model(s), such as, but not limited to, attaching or detaching from the patient, delivering of any interventions, and any monitoring of the patient model(s) can be processed here. In addition, any interactions with all of the other objects and models in the simulation, including the user, can be processed here as well.

In block 709, the state of the Patient Assessment Interface is updated. Any interactions with the patient model(s) such as, but not limited to, assessing physical findings can be processed here. In addition, any interactions with all of the other objects and models in the simulation, including the user, can be processed here as well.

In block 710, the state of the Laboratory is updated. Any interactions with the patient model(s) and all of the other objects and models in the simulation, if needed, can be processed here.

In block 711, metrics about the simulation case are collected from all of the other objects and models in the simulation. In one embodiment, analysis can be done during block 711 as well if relevant (e.g. to provide immediate real-time feedback such as but not limited to a score or some other performance or progress indicator).

In block 712, events notifications which have been sent by any of the other objects and models in the simulation are collected and stored.

In block 713, the state of the context sensitive hint system is updated as needed.

In block 714, the state of the Patient History Interface is updated. Any interactions with the patient model(s) or other objects and models in the simulation, such as, but not limited to, assessing medical history can be processed here.

The user interacts with the simulation models through the simulation interface screen described earlier.

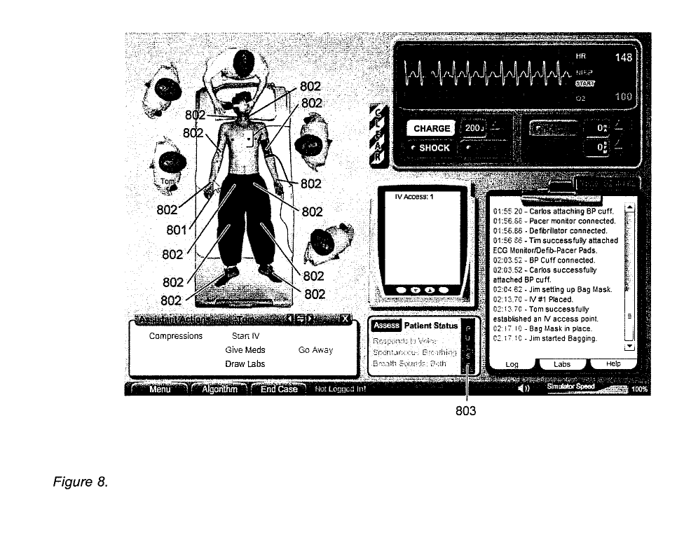

Referring to FIG. 8, to check the patient's pulse, the user may place the mouse cursor over areas on the patient's image where pulses are to be expected. In one embodiment, the closer the cursor is to the actual pulse point on the patient, the larger the impulse that is displayed on a pulse strength meter shown in a Patient Assessment Panel. In one embodiment, the actual pulse point is not visually depicted on the patient image itself so the user will have to estimate where it would be and may have to adjust the cursor position a few times, thus replicating the uncertainty of checking a pulse in real life scenarios, rather than making pulse checking an easy and definitive task. For example, if no impulse is displayed on the pulse strength meter, it does not necessarily mean the patient does not have a pulse. It could be in fact due to the user placing the cursor at an incorrect location, or the patient having a slow pulse that the user did not spend enough time trying to detect.

FIG. 8 illustrates an example screenshot of how to check the patient's pulse. The user puts the mouse cursor 801 or other pointing device over the patient at a location expected to have a pulse 802. If the pulse is found, the pulse strength meter 803 will move up and down in concert with the pulse. In one embodiment, the height of the meter depends on the proximity of the mouse cursor to the actual pulse point, as well as the physiologic state of the patient. In one embodiment, the system may provide feedback to the user using other modalities such as but not limited to audio, tactile, kinesthetic, or other haptic modalities.

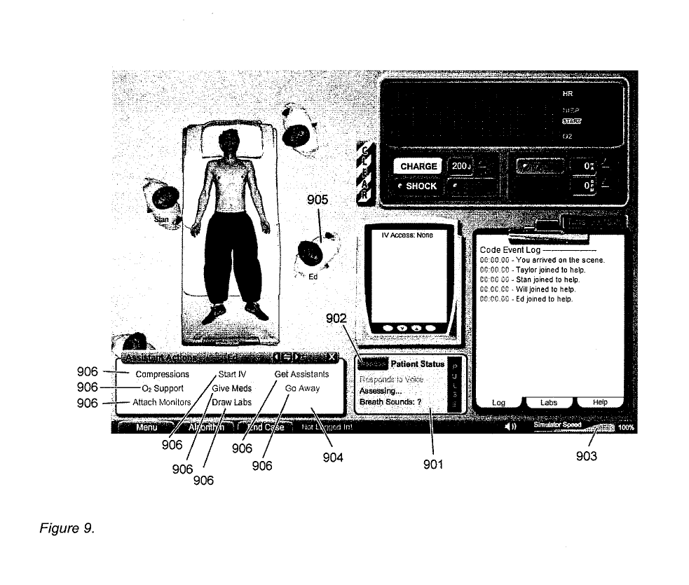

Referring to FIG. 9, to assess the patient's mental status, breathing status, and lung sounds, the user can click on a button in the Patient Assessment Panel to initiate assessment. The assessments are made and displayed on the Panel in a time-delayed manner reflecting the time it takes to perform the actions. The assessment actions can be enhanced by requiring the user to use the mouse cursor to directly interact with the patient in a way similar to the pulse check interface. For example, the user may need to move the mouse cursor over the patient's image to where lung sounds would normally be heard. Then an interface component can indicate if any breathing sounds were detected at that location.

In addition, other user-performed interventions can be presented using the mouse cursor and/or keyboard or other human interface device to interact directly with the patient. For example, a needle thoracostomy could be performed by the user by using the mouse to “feel” the ribs on the patient's chest. When the proper intercostal space (space between ribs) is identified by the user, the user can attempt to insert a needle into the space and observe if there is the intended effect. Other interventions can be simulated using interfaces with similar designs.

FIG. 9 illustrates an example screenshot of how to assess the patient and the Assistant Control Panel 904. After the user activates a control 902 to begin the assessment process, time-delayed assessment results are displayed in the Patient Assessment Panel 901 labeled “Patient Status”. In the example screenshot of FIG. 9, the Simulation Speed gauge 903 is showing an example of 100% simulation speed. A 100% simulation speed indicates the system is running the simulation in real-time. The Assistant Control Panel 904 is shown displaying a set of controls 906 which the user can activate to have the currently selected assistant 905 perform the desired action, or to show additional options.

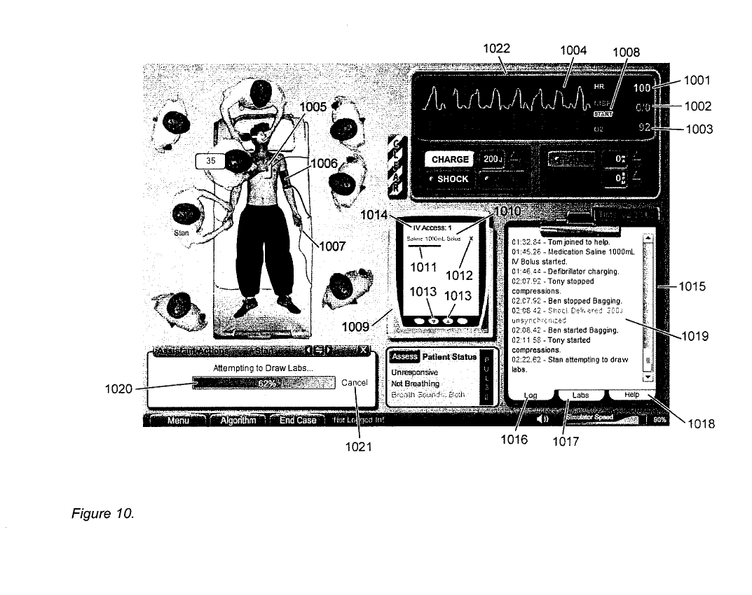

Referring to FIG. 10, vital signs such as, but not limited to, heart rate, oxygen saturation and blood pressure are measured by having one of the assistants connect appropriate monitors to the patient. In one embodiment, an electrocardiogram tracing can also be viewed by having the appropriate monitor connected by an assistant. In one embodiment, a heart rate reading is calculated off of the electrocardiogram tracing so artifacts and inaccuracies in the creation of the electrocardiogram tracing can affect the heart rate reading, just as it can in real-life ACLS scenarios. A blood pressure measurement may be performed over time, with separate assessment points for the systolic and diastolic blood pressures. This reflects the operation of non-invasive blood pressure measuring methods currently used. An oxygen saturation reading is calculated continuously based off of the current state of the patient's physiology model.

FIG. 10 illustrates an example screenshot of the time delay in the performance of actions by the assistants. It also illustrates an example of the IV pump/manager interface 1009 infusing medications. It further illustrates an example of the patient monitors shown in the defibrillator/pacer interface 1023 as well as the clipboard interface 1015. Item 1001 is an example of a heart rate monitor display. Item 1002 is an example of a blood pressure monitor display. Item 1003 is an example of a pulse oximeter monitor display. Item 1004 is an example of an ECG tracing display on the defibrillator/pacer interface 1023. Item 1005 is an example of a display showing that the defibrillator/pacer pads have been attached to the patient. Item 1006 is an example of a display showing that a blood pressure cuff has been attached to the patient. Item 1007 is an example of a display showing that a pulse oximeter has been attached to the patient.

Item 1008 is an example of a control that the user can activate to initiate a non-invasive blood pressure measurement process. Item 1009 is an example of an interface for the IV Pump/Manager. Item 1010 is an example of an interface for a medication being infused by the IV Pump/Manager 1009. Item 1011 is an example of a display on the infused medication indicating the progress of the infusion. Item 1012 is an example of a control which can be activated by the user to stop the infusion of the related medication and remove it from the IV Pump/Manager 1009. Items 1013 are examples of controls on the IV Pump/Manager 1009 which the user can activate to view additional medications being infused in the event that there are more infused medications than shown on the interface at any particular point in the simulation. Item 1014 is an example of a display showing how many IV access points are currently available at that particular point in the simulation. Item 1015 is an example of the Clipboard interface. Item 1016 is an example of the “Log” tab control on the Clipboard interface 1015. In one embodiment, the Clipboard interface 1015 may display the Case Log 1019 when the Case Log is activated by the user. Item 1017 is an example of the “Labs” tab control on the Clipboard interface 1015. When activated by the user, the Clipboard interface 1015 will display the Lab values interface. Item 1018 is an example of the “Help” tab control on the clipboard interface 1015. When activated by the user, the Clipboard interface 1015 will display the context-sensitive help system interface. Item 1019 is an example of the Case Log interface. Item 1020 is an example of a display showing the progress of an action being performed by the currently selected assistant. Item 1021 is an example of a control that the user can activate to stop the currently selected assistant from performing the action that was in-progress. Item 1023 is an example of the Defibrillator/Pacer interface.

Referring to FIG. 10, an IV pump interface displays the medications being infused and the progress of the infusion. The user can choose to stop any particular infusion through the IV pump interface. The IV pump interface also indicates how many IV access sites are available for use at any point in time.

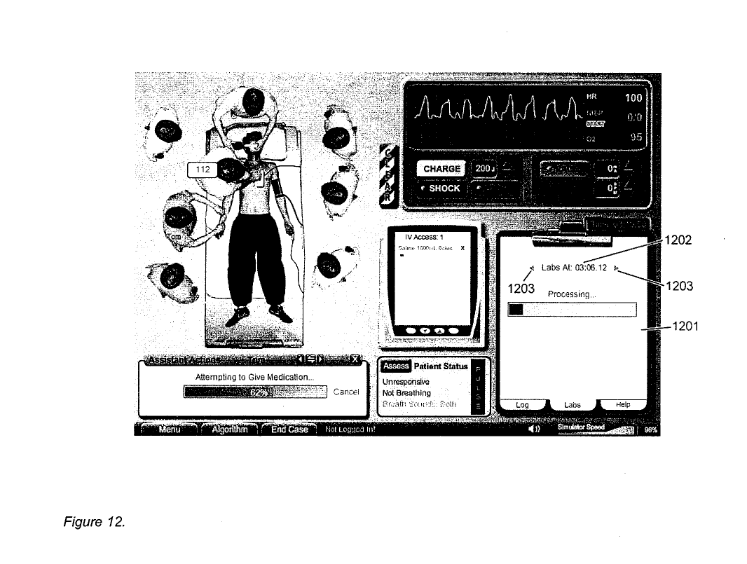

A Clipboard interface, which has three tabs in one embodiment, is located, for example, on the right side of the simulation interface of FIG. 10. A “Log” tab on the Clipboard interface can show a log of the events that have occurred in the simulation which the user can review at any time during the simulation. A “Labs” tab can show lab data gathered during the simulation that can be reviewed at any time during the simulation. The availability of the lab data, as shown in FIG. 12, may be delayed after acquisition of blood samples by an assistant to reflect the passage of time for processing the samples. The lab data is calculated based off the state of the patient's physiology model at the time the blood samples were acquired by the assistant.

The electrocardiogram tracing on the defibrillator/heart monitor is calculated in real-time on a frame-by-frame basis based on the state of the patient's physiology model as well as interventions being performed on the patient. Pacing, cardioversion and defibrillation are performed by the user through a defibrillator/pacer/heart monitor device that delivers electrical interventions to the patient.

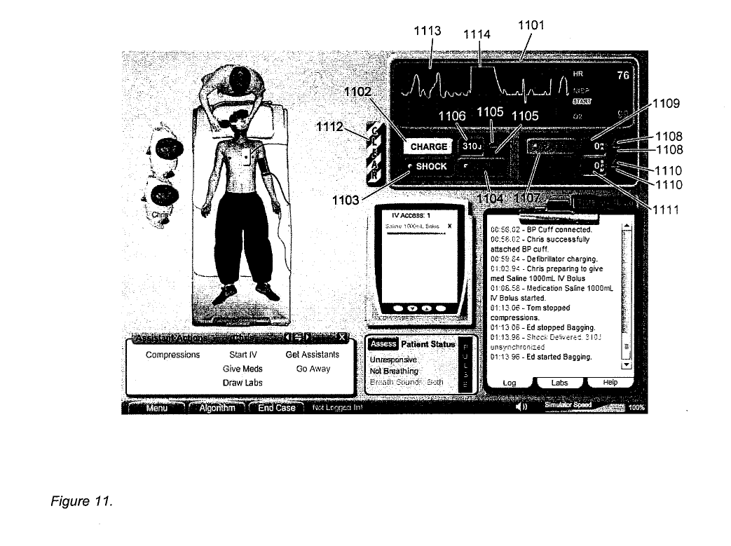

Standard controls for those interventions are found on the defibrillator interface illustrated in FIG. 11. A button next to the defibrillator allows for the user to “clear the patient,” which stops assistants who are touching the patient at the time and makes them step away. In the event cardioversion or defibrillation is performed while an assistant(s) is still in contact with the patient, the assistant(s) can be animated as being affected by the electrical discharge, for example, by leaving the personnel area and removed from the simulation itself. The success or failure of the cardioversion and defibrillation may be dependent on characteristics and timing of the intervention relative to the physiologic state of the patient, as well as other constraint-based, or unconstrained, random variables. The success or failure of pacing interventions may depend on the characteristics and physiologic state of the patient.

FIG. 11 illustrates an example screenshot of the defibrillator/pacer and defibrillation. Item 1101 is an example of the defibrillator/pacer interface. Item 1102 is an example of a control which the user can activate to charge the defibrillator. Item 1103 is an example of a control which the user can activate to deliver an electrical intervention to the patient. Item 1104 is an example of a control which the user can activate to enable or disable the synchronization feature of the defibrillator. Item 1105 is an example of controls which the user can activate to increase and decrease the energy setting for the defibrillator. Item 1106 is an example of a display which indicates the current energy setting on the defibrillator. Item 1107 is an example of a control which the user can activate to turn on or off the pacing feature of the defibrillator. Item 1108 is an example of controls which the user can activate to increase or decrease the current to be used during pacing. Item 1109 is an example of a display indicating the current amount of current to be delivered to the patient during pacing. Item 1110 is an example of controls which the user can activate to increase or decrease the pacing rate. Item 1111 is an example of a display indicating the current rate pacing is to be performed. Item 1112 is an example of a control which the user can activate to “clear” the patient and have the assistants to terminate their contact with and increase their distance from the patient and bed. Item 1113 is an example of an ECG tracing display. Item 1114 is an example of a “spike” on the ECG tracing display which can be shown as a result of a defibrillation event.

FIG. 12 illustrates an example screenshot of the time delay in the laboratory processing of a blood sample drawn from the patient. Item 1201 is an example of a display showing the progress of the processing of a particular blood sample drawn from the patient. Item 1202 is an example of a display showing the time identifier for the particular blood sample data being viewed. Item 1203 is an example of controls which the user can activate to navigate through the available lab data including ones that are still being processed.

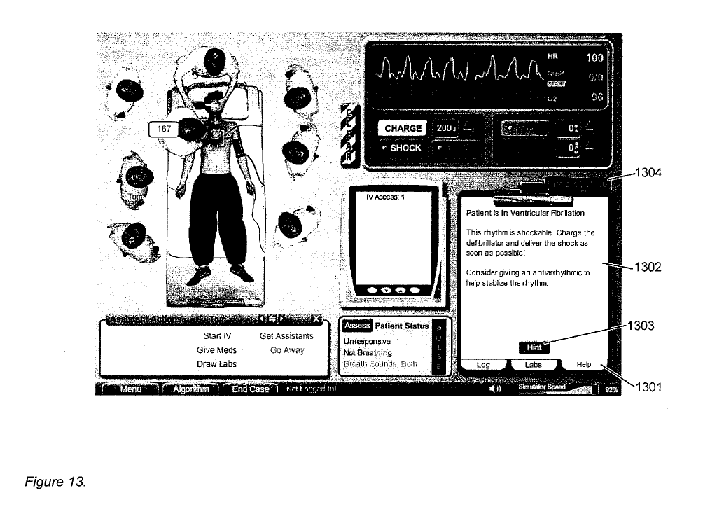

A “Help” tab, illustrated in the example screenshot of FIG. 13, can contain an intra-simulation context-sensitive hint system when available. In one embodiment, when the user clicks on a “hint” button in this tab, a suggested action that will further the scenario (if available) can be displayed. These suggestions actions are chosen based on the state of the simulation when the “hint” button is pressed. On the top right of the clipboard interface, for example, there is a timer display which shows the time elapsed in the simulation scenario.

FIG. 13 illustrates an example screenshot of the context-sensitive help system interface. Item 1301 is an example of the “Help” tab control which, when activated, displays the context-sensitive help system interface. Item 1302 is an example of the context-sensitive help system interface. Item 1303 is an example of a control which the user can activate to bring up, if available, hint information relative to the current state of the simulation. Item 1304 is an example of the timer clock display which indicates the elapsed simulation time since the beginning of the simulation.

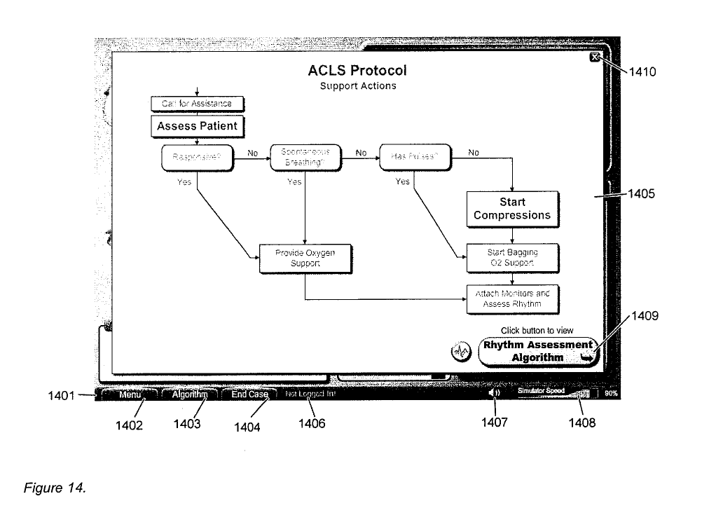

Referring to FIGS. 14-16, there is a “taskbar” at the bottom of the simulation interface screen that contains several components in the form of three buttons. The first button (“Menu”) allows the user to pause the simulation and access a menu. This menu allows the user to resume the simulation, restart the scenario, or quit the scenario prematurely and return to a pre-simulation menu. The next button (“Algorithm”), when available, allows the user to view “ACLS cards,” which contain guides on the resuscitation protocols. These guides may be presented in different panels that the user can click through to view. In addition, the panels can have additional information displayed through tooltips (e.g. pop-up boxes). This “layering” of the information allows users to obtain only the amount of support they need to supplement the knowledge they already possess. In one embodiment, while these interactive guides are being viewed, the simulation continues to run to reflect situations in real resuscitation events where the event continues to evolve even while user is studying a resource. The third button (“End Case”) allows the user to end the case prematurely and be presented with a debriefing screen which displays feedback on the simulation to the user.

Also on the taskbar are a display for the user's name, a simulation sound volume control interface, and a simulation speed gauge. The simulation speed gauge displays how fast the simulation is running relative to true time (passage of time in real life). At 100%, the passage of time in the simulation is occurring at the same speed as true time. This allows users to recognize whether time intervals presented in the simulation are accurate relative to true time or not. This may be useful when the simulation is being run on an insufficiently powered computer. When the simulation is running at the speed of true time, users can learn the timing of interventions from the simulator (e.g. chest compression rates).

FIG. 14 illustrates an example screenshot of the “ACLS Cards” panel displaying Basic Life Support procedures. It also illustrates an example of the “taskbar” interface. Item 1401 is an example of the “taskbar” interface which contains information about the simulation itself as well as controls which the user can activate to access additional options and information. Item 1402 is an example of a control which the user can activate to pause the simulation and also access a menu with additional options such as but not limited to resuming the simulation, restarting the case, or returning to the main menu. Item 1403 is an example of a control which the user can activate to view the ACLS Protocol reference “cards” (1405 is an example of one such “card”). In one embodiment, the simulation may still be running when the user is viewing this reference. Item 1404 is an example of a control which the user can activate to stop the simulation prematurely and view the simulation debriefing displays. Item 1405 is an example of an ACLS Protocol reference “card” display. Item 1406 is an example of a display which can display additional information to the user such as but not limited the username of the currently logged in user and/or the status of the login. Item 1407 is an example of a control which the user can activate to adjust the volume, including muting, of any audio in the simulation. Item 1408 is an example of the Simulation Speed gauge. Item 1409 is an example of a control which the user can activate on the ACLS Protocol “card” to view the next relevant ACLS Protocol “card”. Item 1410 is an example of a control which the user can activate to remove the ACLS Protocol “card” display.

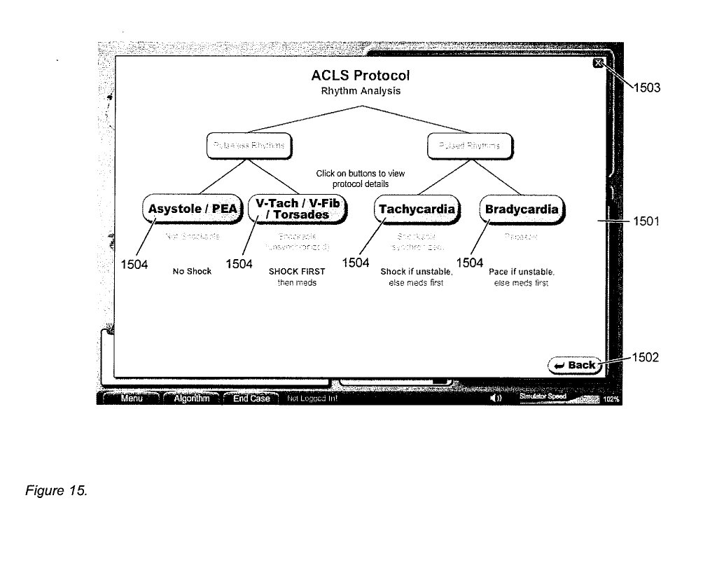

FIG. 15 illustrates an example screenshot of the “ACLS Cards” panel displaying various rhythms and their categorization. Item 1501 is an example of an ACLS Protocol reference “card” display. Item 1502 is an example of a control which the user can activate on the ACLS Protocol “card” to view the previous relevant ACLS Protocol “card”. Item 1503 is an example of a control which the user can activate to remove the ACLS Protocol “card” display. Item 1504 is an example of controls which the user can activate on the ACLS Protocol “card” to view another ACLS Protocol “card”.

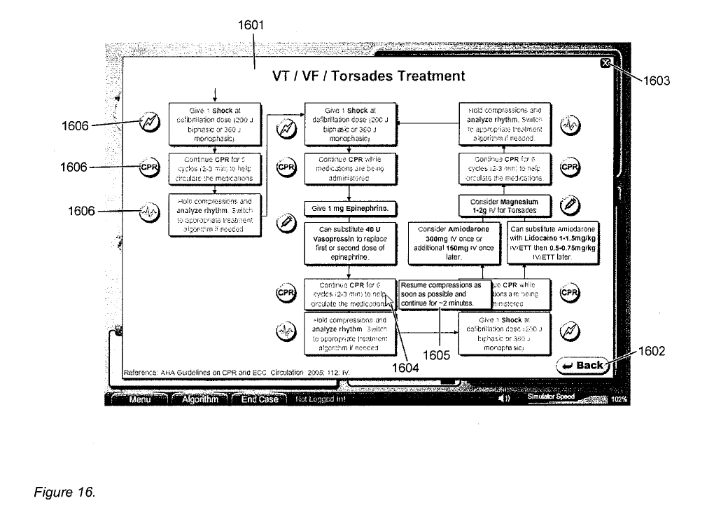

FIG. 16 illustrates an example screenshot of the “ACLS Cards” panel displaying detailed protocols for a particular rhythm. Item 1601 is an example of a ACLS Protocol reference “card” display. Item 1602 is an example of a control which the user can activate on the ACLS Protocol “card” to view the previous relevant ACLS Protocol “card”. Item 1603 is an example of a control which the user can activate to remove the ACLS Protocol “card” display. Item 1604 is an example of the user's mouse cursor over an information box. Item 1605 is an example of a display which appears when the user's mouse cursor is over an information box. These “pop-up” information boxes show increased details only when the user activates them through a control mechanism such as but not limited to “mousing over” certain parts of the ACLS Protocol “card” display. Items 1606 are examples of “action icon” displays which provide quick categorical guidance to the user. This provides yet different layer of detail that the user can choose to use instead of or in addition to other details.

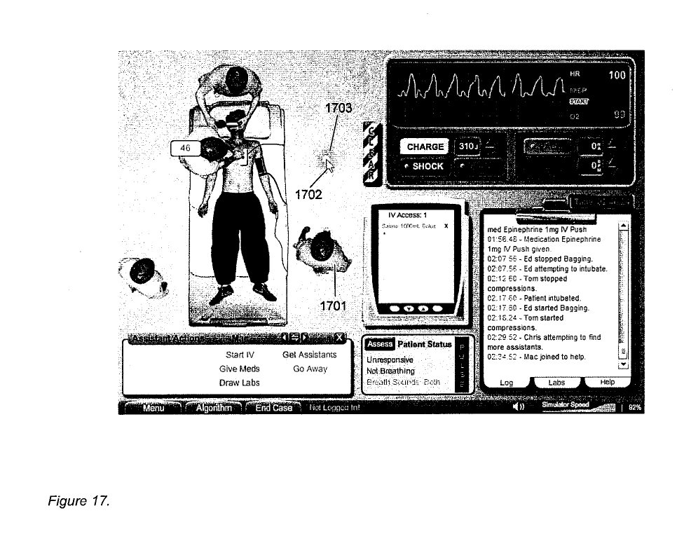

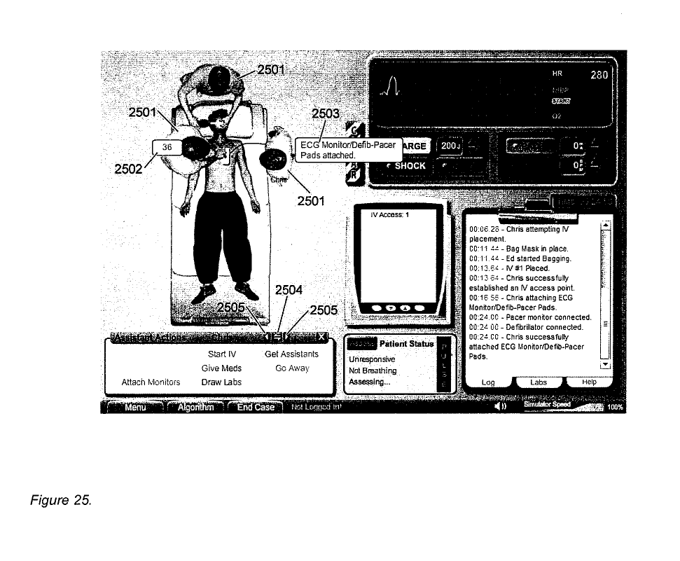

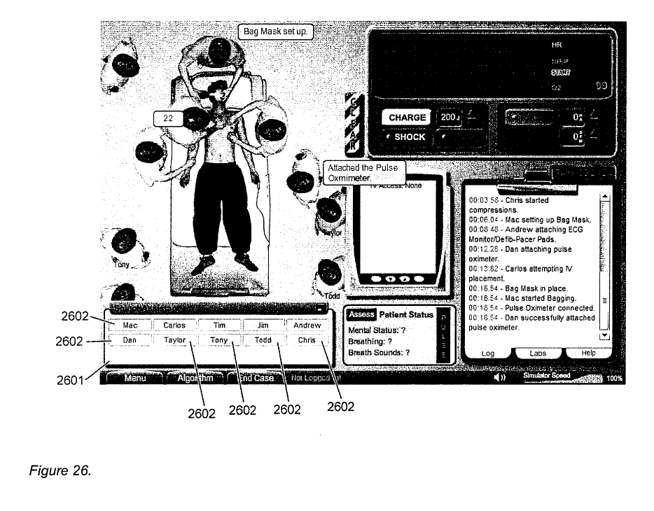

The user interacts with the assistants by clicking on a specific assistant image to select them. Alternatively, the user can go to an Assistant Selection panel, illustrated in FIG. 26, and select an assistant from the panel. Another option that can be available to the user is the use of the certain controls on an input device such as a keyboard, or to use assistant selection controls 2505 as illustrated in FIG. 25. When selected, the assistant may be moved to any available area in the personnel interaction area by clicking on an empty space. The assistant will then “walk” to that location as shown in FIG. 17.

FIG. 17 illustrates an example screenshot of the assistant walking to the point the user selected. Item 1701 illustrates the currently selected assistant. Item 1702 illustrates the user's mouse cursor. Item 1703 is an example of a display indicating the location where the user wants the assistant to move. This display is usually, but does not necessarily have to be, shown after the user clicks or otherwise selects the indicated target location.

In one embodiment, when an assistant is clicked, an Assistant Control Panel will appear that provides a menu of actions that can be performed. The menu includes actions in categories such as, for example, compression, oxygen therapy, attaching monitors, starting IVs, administering medications, drawing blood samples for lab work, getting more assistants, and going away. These options can have submenus that allow further choices.

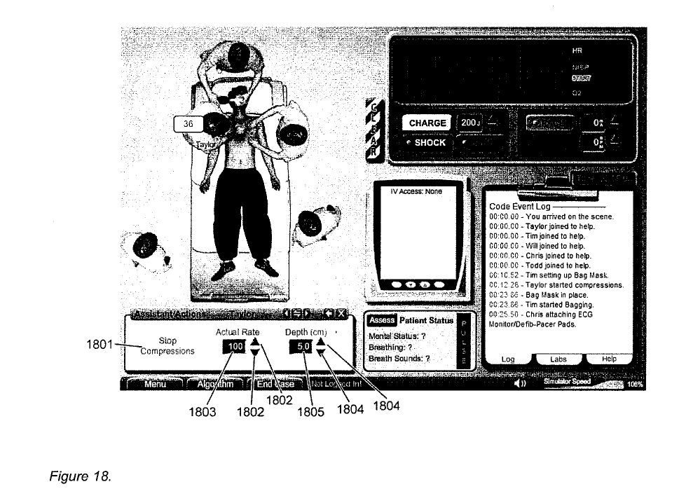

A Compression Submenu can be used to start and stop compressions and adjust rate and depth. FIG. 18 illustrates an example screenshot of options in the Compression Submenu. Item 1801 is an example of a control which the user can activate to have the currently selected assistant start or stop chest compressions. Item 1802 is an example of controls which the user can activate to increase or decrease the rate of chest compressions being performed by the currently selected assistant. Item 1803 is an example of a display which shows the current rate of chest compressions being performed by the currently selected assistant. Item 1804 is an example of controls which the user can activate to increase or decrease the depth of chest compressions being performed by the currently selected assistant. Item 1805 is an example of a display which shows the current depth of chest compressions being performed by the currently selected assistant.

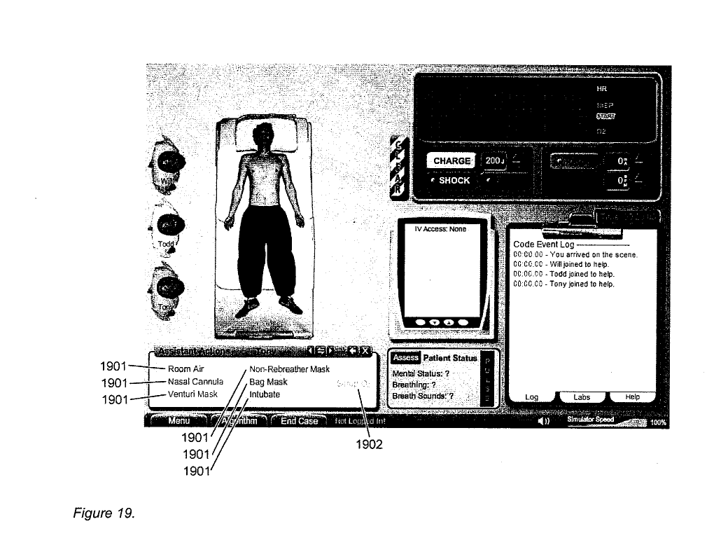

An Oxygen Support Submenu can be used to select from options such as, for example, Room Air, Nasal Cannula, Venturi Mask, Non-rebreather Mask, Bag Mask, Intubation. FIG. 19 illustrates an example screenshot of options in the Oxygen Support Submenu. Item 1901 is an example of controls which the user can activate to select different oxygen support options to be setup by the currently selected assistant. Item 1902 is an example of a control which the user can activate to confirm the selected option and have the assistant begin performing the selected option.

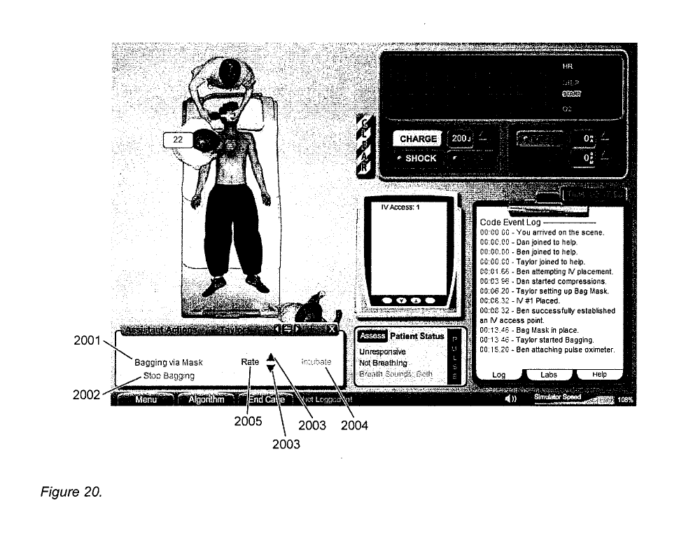

When a bag mask has been attached earlier, the option to begin bagging is available. When bagging is in process, options to adjust the bagging rate are available. When the patient is on a bag mask, the option to intubate is available from the bagging submenu. FIG. 20 illustrates an example screenshot of the bagging options. Item 2001 is an example of a display which shows which airway device and/or method is being used for performing ventilations. Item 2002 is an example of a control which the user can activate to stop the currently selected assistant from performing bagging ventilation. Item 2003 is an example of controls which the user can activate to increase or decrease the bagging ventilation rate being performed by the currently selected assistant. Item 2004 is an example of a control which the user can activate to have the currently selected assistant to begin attempting intubation. Item 2005 is an example of a display which could show the rate bagging ventilation is being performed by the currently selected assistant. In this example, a numeric display is not shown so that the user can practice monitoring ventilation rates based on other methods that would be used in real life scenarios (e.g. such as counting the number of seconds passed between each delivered ventilation). In one embodiment, a numeric display may be shown to assist the user in monitoring ventilation rates.

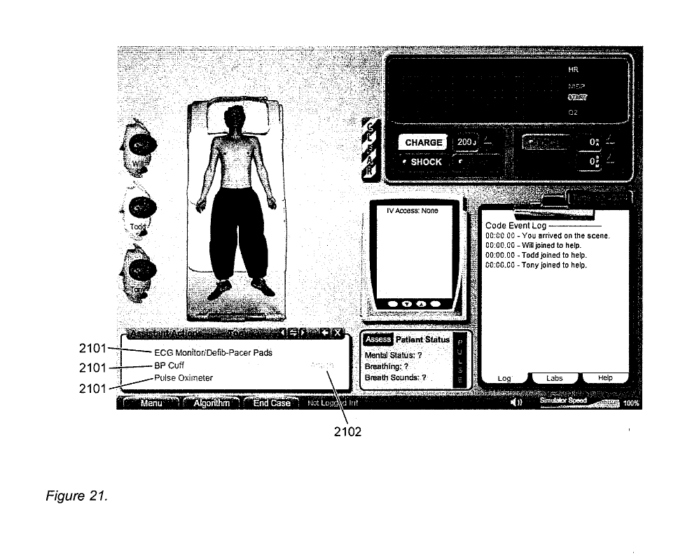

An Attach Monitors Submenu can be used to attach, for example, ECG Monitor/Defibrillator/Pacer, blood pressure cuff, pulse oximeter, 12-lead ECG, end-tidal carbon dioxide partial pressure (i.e. PetCO2). FIG. 21 illustrates an example screenshot of the Attach Monitors Submenu options. Item 2101 is an example of controls which the user can activate to select different monitors to be setup and attached to the patient by the currently selected assistant. Item 2102 is an example of a control which the user can activate to confirm the selected option and have the assistant begin performing the selected option.

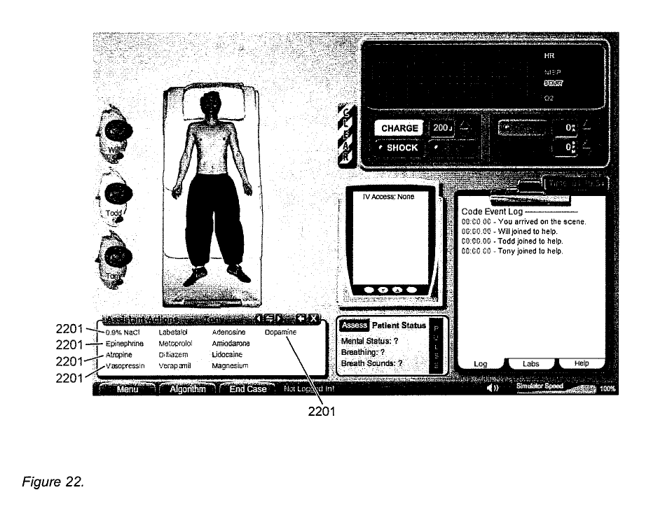

A Give Medications Submenu displays a list of medications, each with another submenu for choosing a dose and administration route when available. FIG. 22 illustrates an example screenshot of the Give Medications Submenu options. Item 2201 is an example of controls which the user can activate to select different medications to be prepared and administered by the currently selected assistant. In one embodiment, activating one of the controls can bring up another submenu which presents further options regarding medication dosage and administration route.

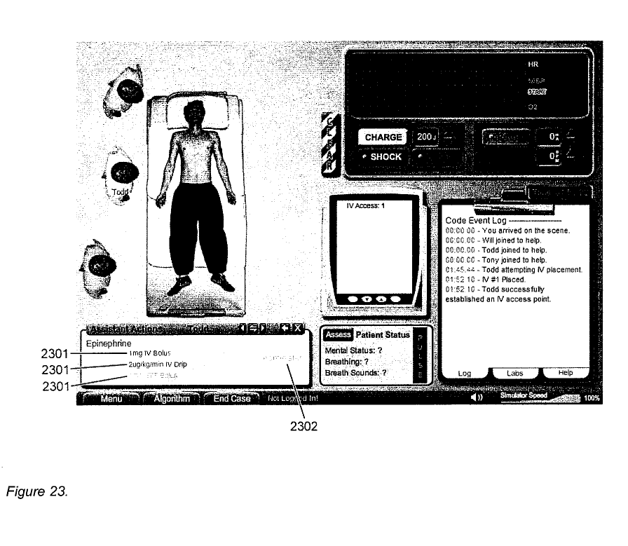

FIG. 23 illustrates an example screenshot of the medication subpanel with dosage and administration route options. Item 2301 is an example of controls which the user can activate to select available medication dosages and/or administration route options. Item 2302 is an example of a control which the user can activate to confirm the selected option and have the currently selected assistant begin performing the selected option.

A Draw Labs Submenu can be used to select, in a non-exclusive manner, which tests to run on acquired patient blood samples. These tests can include, for example, Arterial Blood Gas (ABG), glucose, sodium, potassium, magnesium, calcium.

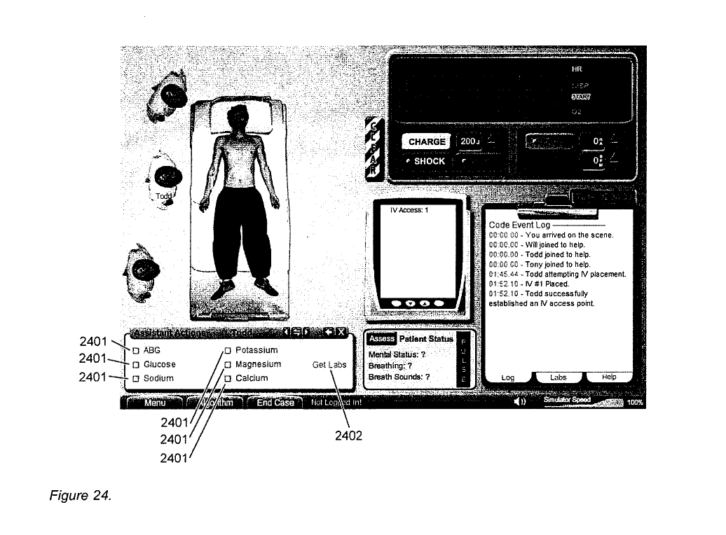

FIG. 24 illustrates an example screenshot of the Draw Labs Submenu options. Item 2401 is an example of controls which the user can activate to select nonexclusively which lab studies to be performed on blood sample to be drawn by the currently selected assistant. Item 2402 is an example of a control which the user can activate to confirm the selected lab studies and have the assistant begin performing the blood draw and subsequent lab studies.

Referring to FIG. 25, when an action is chosen from the Assistant Control Panel, the assistant moves to the appropriate location on the screen and begins performing the action. The action can be canceled at anytime through the Assistant Control Panel. Actions take variable times to complete and as described earlier, the success rates of the actions can also be variable. Because the actions take time to complete, multiple assistants can be assigned to perform tasks in parallel, as is possible in real resuscitation events. This allows for a non-linear simulation experience. In one embodiment, depending on the choices taken by the user, the patient status can improve and deteriorate back and forth depending on the physiologic model, thus increasing the non-linearity of the simulation. When assistants perform actions, or attempt to perform actions, they provide feedback to the user, for example, with speech bubbles and/or voice. The sentiment of the messages can be indicated by the appearance of the speech bubbles. For example, green speech bubbles can indicate communication with a positive sentiment (e.g. successfully completing a procedure), red speech bubbles can indicate negative sentiment (e.g. failed attempt), and yellow speech bubbles can be used indicate neutral sentiment (e.g. counting chest compressions).

FIG. 25 illustrates an example screenshot of the speech bubbles and several assistants performing different tasks simultaneously. Green speech bubbles can indicate positive sentiment. Yellow speech bubbles can indicate neutral sentiment. Red speech bubbles (not shown) can indicate negative sentiment. Items 2501 are examples of different instances of assistants performing different tasks at the same time. Item 2502 is an example of a neutral sentiment speech bubble. Item 2503 is an example of a positive sentiment speech bubble. Item 2504 is an example of a control which the user can activate to display the Assistant Selection panel. Item 2505 is an example of controls which the user can activate to cycle through the currently selectable assistants.

FIG. 26 illustrates an example screenshot of the Assistant Selection panel. This interface can be used to select an assistant when their image cannot be clicked on with the mouse cursor or other input device due to overlap by other images or for other reasons. Item 2601 is an example of the Assistant Selection Interface. Item 2602 is an example of controls the user can activate to select any of the assistants that are currently available for selection.

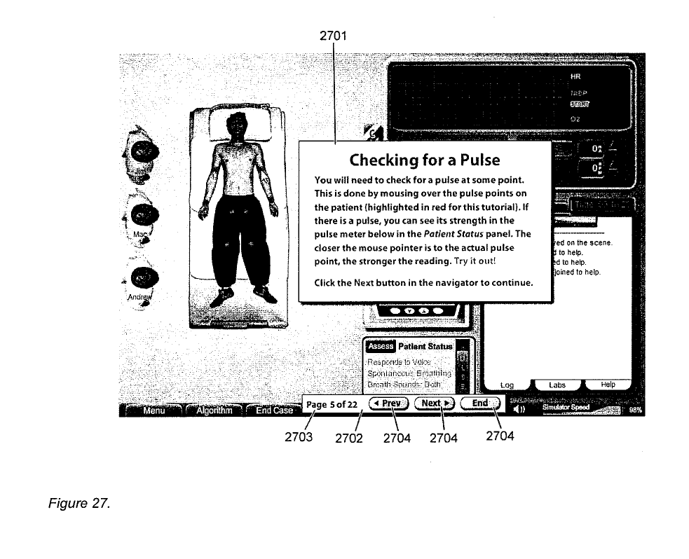

FIG. 27 illustrates an example screenshot of a page from the Tutorial Mode. Item 2701 is an example of a display showing tutorial related information. Item 2702 is an example of an interface which allows the user to navigate through the pages of the tutorial. Item 2703 is an example of a display which indicates which page of the tutorial is currently being displayed. Item 2704 is an example of controls which the user can activate to move forward or backward through the tutorial pages, or to exit the tutorial.

Referring back to FIG. 6, the simulation continues until the patient is detected as stabilized for a pre-determined period of time, the patient is detected to have expired, the user chooses to end the simulation prematurely and see debriefing, or the user chooses to end the simulation prematurely and return to the pre-simulation menus. If the patient is detected as stabilized for a pre-determined period of time, the simulator continuously monitors the patient to see if physiologic model parameters are within pre-determined “stable” limits. If the parameters are detected to have remained stable for the pre-determined period of time, the debriefing screen automatically appears. If the patient is detected to have expired, the debriefing screen automatically appears. If the user chooses to end the simulation prematurely and see the debriefing, the user selects to end the case and the debriefing screen is shown based on the events that have occurred in the simulation. If the user chooses to end the simulation prematurely and return to the pre-simulation menus, the user is returned to the appropriate pre-simulation menu and no debriefing screen is displayed.

The simulator is designed to be able to operate asynchronously, as well as synchronously. Therefore, in the alternative, the simulator could be processed on multiple computers, or receive inputs from multiple users on multiple computers. This multi-user system would allow the practice of team work between multiple users using the system on multiple computers connected via a network. In the multi-user system, one person would preferably be designated as the resuscitation team leader, as is recommended in real resuscitation events. Then the resuscitation team leader would direct the other users to perform certain tasks and interventions. The other users would then attempt to perform the delegated tasks and report the results to the resuscitation team leader.

During the simulation, the simulator continuously measures performance metrics relevant to the particular situation. These metrics include, but are not limited to, items such as compression fraction (or percentage), average compression rate, time to defibrillation or other action, bagging rate, etc. Once the simulation ends and the debriefing screen is being prepared for display, the performance metrics are calculated, displayed, and also sent to a data server for storage.

As illustrated in FIG. 28, the performance metrics are also correlated with a grade to help the user understand the quality of the user's performance during the scenario. FIG. 28 illustrates an example screenshot of the grade breakdown on the Case Debriefing Panel. Item 2801 is an example of the Case Debriefing Panel interface. Item 2802 is an example of a display showing the metrics recorded during the simulation. When the user hovers the mouse over a metric or uses a similar input mechanism, a display 2804 showing the grade brackets for that metric can be displayed. Item 2803 is an example of a display showing grades that correlate with the metrics recorded during the simulation. When the user hovers the mouse over a metric or uses a similar input mechanism, a display 2804 showing the grade brackets for that metric can be displayed. Item 2804 is an example of a display which shows the metrics parameters or ranges which are assigned to the various letter grades for any particular metric. Item 2805 is an example of controls which the user can activate to display various components of the case debriefing such as but not limited to the “Grade Breakdown” and the “Case Overview”. Item 2806 is an example of a control which the user can activate to show the interface that displays recorded tracings from the simulation. Item 2807 is an example of an interface which shows the recorded case log from the simulation. Item 2808 is an example of a control that the user can activate to retry the same simulation. Item 2809 is an example of a control that the user can activate to start a new simulation of the same initial patient rhythm type. Item 2810 is an example of a control that the user can activate to return to a pre-simulation menu. Item 2811 is an example of a display that shows the outcome of the patient at the end of the simulation (e.g. alive, deceased, unknown). Item 2812 is an example of a display that indicates the total elapsed simulation time. Item 2813 is an example of a display that indicates the overall weighted grade assigned to the simulation based on the performance metrics that were recorded.

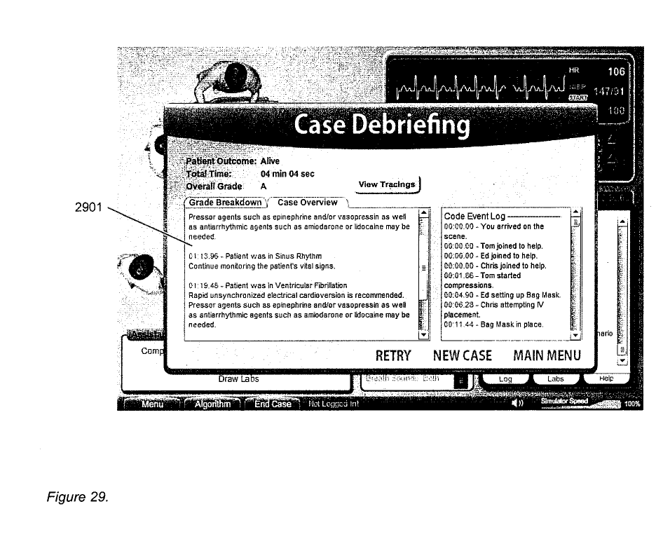

As illustrated in FIG. 29, the debriefing also displays the rhythms the simulated patient went through and shows what some recommended actions would be. In one embodiment, the systems can also provide feedback on the appropriateness of medications and other interventions performed during the simulation. In the event the simulation scenario was not completed successfully, it can also provide suggestions on additional interventions which could have been performed to complete the scenario. FIG. 29 illustrates an example screenshot of the case overview on the Case Debriefing Panel. Item 2901 is an example of an interface which can display various details of the simulation such as the rhythms the patient went through, recommended interventions, feedback on interventions selected by the user, and other relevant information.

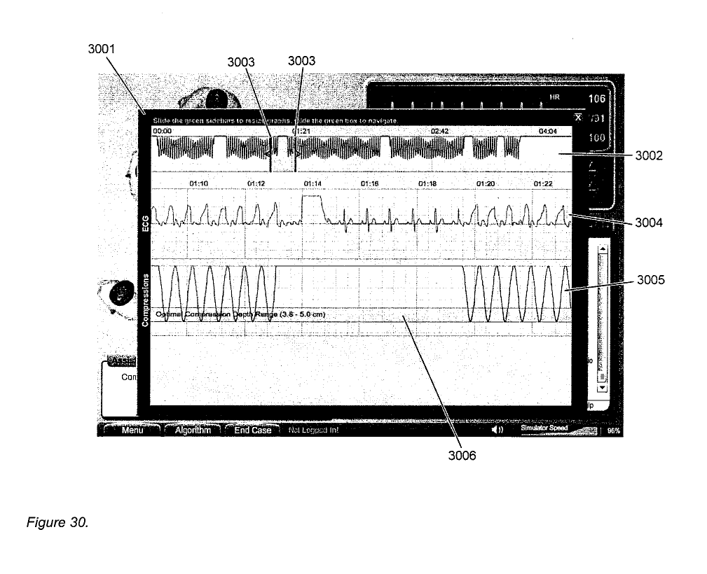

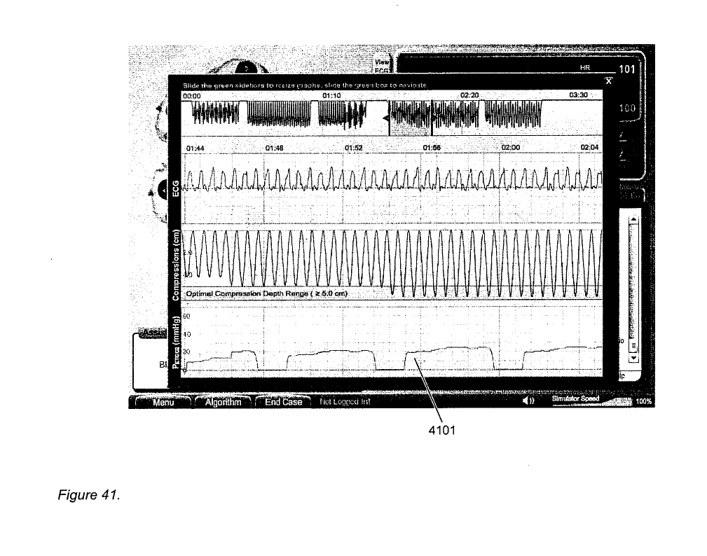

Also available in the debriefing is a display of “tracings” of interventions such as chest compression waveforms shown in FIG. 30 and FIG. 41. The tracings allow users to easily assess the quality of the chest compressions being performed during the scenario, as well as the length of pauses between compression groups. In one embodiment, the system can store a copy of the simulated scenario so that it could be replayed back at a later time for review by the user and/or other people.

FIG. 30 illustrates an example screenshot of the “tracings” display which can depict tracings of the ECG and of chest compressions waveforms performed during the simulation. Item 3001 is an example of a display showing the tracings recorded during the simulation. Item 3002 is an example of an interface which the user can use to adjust the time position and time window of the tracing displays such as item 3004 and item 3005. Item 3003 is an example of controls that the user can use, for example by clicking and dragging, to adjust the time position and time window of the tracing displays such as item 3004 and item 3005. The control on the left indicates the time position for the left side of the tracing displays and the right control indicates the time position for the right side of the tracing displays. The farther apart the two controls are, the larger the time window is displayed in the tracing displays. Item 3004 is an example of a display which shows the ECG tracings recorded during the simulation. Item 3005 is an example of a display which shows the chest compression tracings recorded during the simulation. Item 3006 is an example of a display which shows the optimal depth range for the deepest part of each chest compression.

Alternatively, the tracing viewer in the debriefing screen can be extended to show other measurements such as, for example, the patient's respiratory patterns, end-tidal CO2, invasive blood pressure, and other measurements used in the course of medical treatment. In addition, the viewer can have the events that occurred in the simulation (e.g. procedure completed) displayed, for example, as an overlay on top of the tracings. This would provide an easily interpretable graphical representation of the evolution of the scenario and can facilitate identification of areas for improvement.

In one embodiment, the simulator can further include an interactive patient history acquisition system. This would reflect the acquisition of patient history information as it usually occurs in real-life resuscitation events. For example, when the simulation scenario begins and the user initiates the appropriate initial interventions, the user can send an assistant out to gather some specific parts of the patient's history. When the assistant returns with or without the requested information, the user can then tailor decisions and actions based on the updated body of information, including requesting more information. Another example would be to have a non-playable-character (NPC) in the simulation that could represent the patient's family member or some other person. This NPC can sporadically offer information, or even hinder the users' actions, as sometimes occurs in real resuscitation events.

Performance Data Review Module for Users

In one embodiment, the system further includes a User Performance Data Review module providing a way for the user to access the performance data acquired from cases performed on the simulator. It can allow review of the data on a case-by-case basis as well as in aggregated form and visualized graphically. The user can choose from several panels, described below, that provide access to different aspects of the data.

Overview Panel

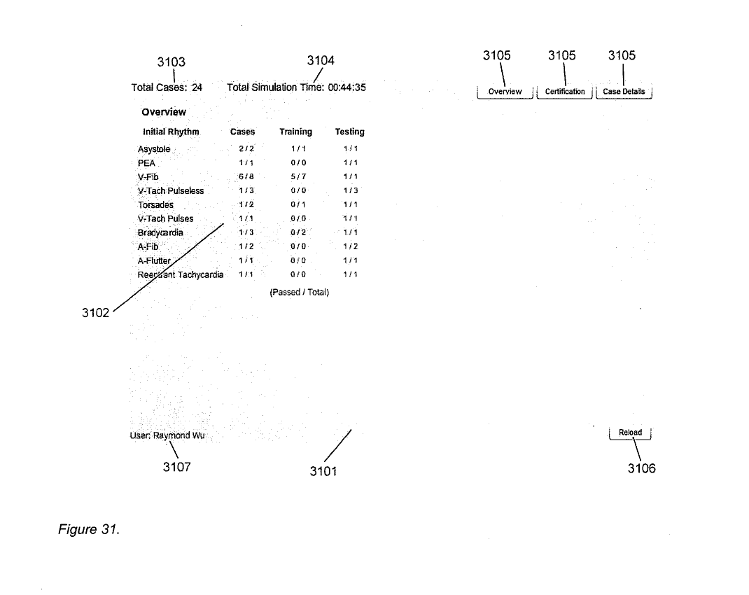

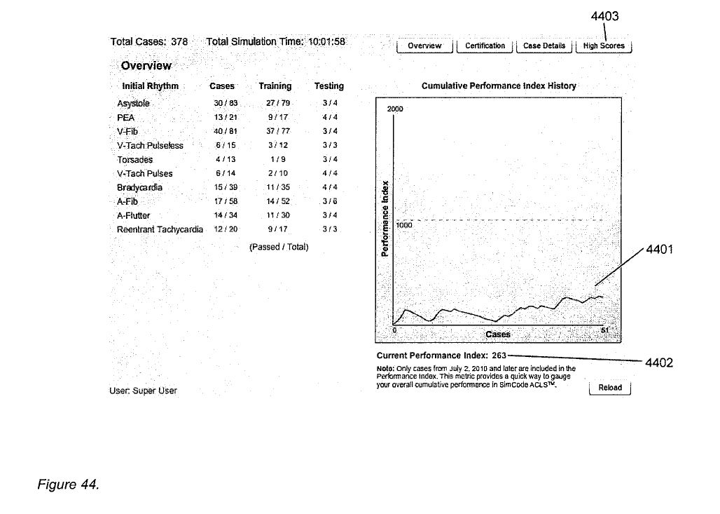

An Overview panel, illustrated in FIG. 31, gives a summary of the case data. For example, it can display the number of completed cases categorized into training mode and initial patient-rhythm type. It can also display how many cases of each category were passed and how many were attempted. Illustrated in FIG. 44, a performance history index score and graph can also be displayed on the Overview panel. The performance history index score is a number which represents the cumulative score from each simulation case performed by the user. The performance history index graph displays the change in cumulative score so the user can easily identify if his performance is improving or otherwise. Other data which the user could access quickly can be displayed here as well.

FIG. 31 illustrates an example screenshot of the Overview Panel from the Performance Data Review Module for Users. Item 3101 is an example of the interface for the Overview Panel. Item 3102 is an example of a display which shows a summary of the case performed. The information can be analyzed by the total number of cases done in training and testing modes and categorized by the initial patient rhythm type. Other ways of analyzing the data can also be displayed here as well. Item 3103 is an example of a display showing the total number of simulation cases performed by this user. Item 3104 is an example of a display showing the cumulative time spent using the simulator by this user. Item 3105 is an example of controls that the user can activate to navigate between different panels in the Performance Data Review Module for Users. Item 3106 is an example of a control that the user can activate to reload and refresh the data displayed by the Performance Data Review Module for Users. Item 3107 is an example of a display that can show additional information such as, but not limited, to the current user's name.

Certification Panel

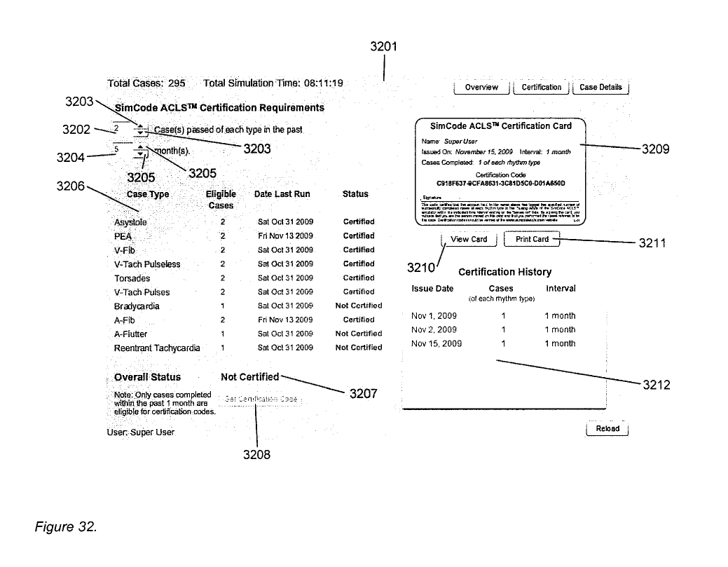

A Certification panel, illustrated in FIG. 32, allows the user to choose parameters to determine certification strength and to view relevant case data. For example, the user can adjust the number of cases required to be successfully completed of each initial patient rhythm. In one embodiment, the user can also adjust how recent the cases need to be completed in order to be counted toward certification (e.g. only count cases in the last three months). After adjusting the certification parameters, the case data is automatically filtered according to the parameters and then analyzed. A display details when the most recent case of each initial patient rhythm was completed, along with whether the user has met the chosen certification parameters for that initial patient rhythm. In one embodiment, the display illustrated in FIG. 32 also shows whether the user is overall “certified” (meets the chosen certification parameters for all of the initial patient rhythms).

FIG. 32 illustrates an example screenshot of the Certification panel from the Performance Data Review Module for Users. Item 3201 is an example of the Certification panel interface. Item 3202 is an example of a display showing the current certification setting for the number of cases of each case type that need to be passed. Item 3203 is an example of controls that the user can use to increase or decrease the number cases of each case type that need to be passed for certification. Item 3204 is an example of a display showing the current certification setting for the most recent time period during which the cases need to be passed to count towards certification. Item 3205 is an example of controls that the user can use to increase or decrease the length of the most recent time period during which the cases need to be passed to count toward certification. Item 3206 is an example of a display that shows information about the cases which match the certification parameters show in 3202 and 3204. The information can be categorized by case type (initial patient rhythm type) and can include, but is not limited to, the number of eligible cases, the date the last eligible case was run, and the certification status for that particular case type. In one embodiment, this display can be updated whenever certification parameters are changed. Item 3207 is an example of a display that shows the overall certification status for the selected certification parameters shown in 3202 and 3204. Item 3208 is an example of a control that the user can activate to request a certification code to be generated for the selected certification parameters. This control would be enabled only when the selected certification parameters are met. Item 3209 is an example of a display that shows the currently selected certification card, if any. Different cards can be selected to be displayed by the user from the certification history interface 3212. The user can also view a larger version of the certification card by clicking on the card display itself. Item 3210 is an example of a control that the user can use to view a larger version of the certification card. Item 3211 is an example of a control that the user can use to print a copy of the certification card. Item 3212 is an example of an interface that displays the certification history and associated parameters for the user. The user can select different certification cards for viewing by clicking on the display that corresponds to the certification that is to be viewed.

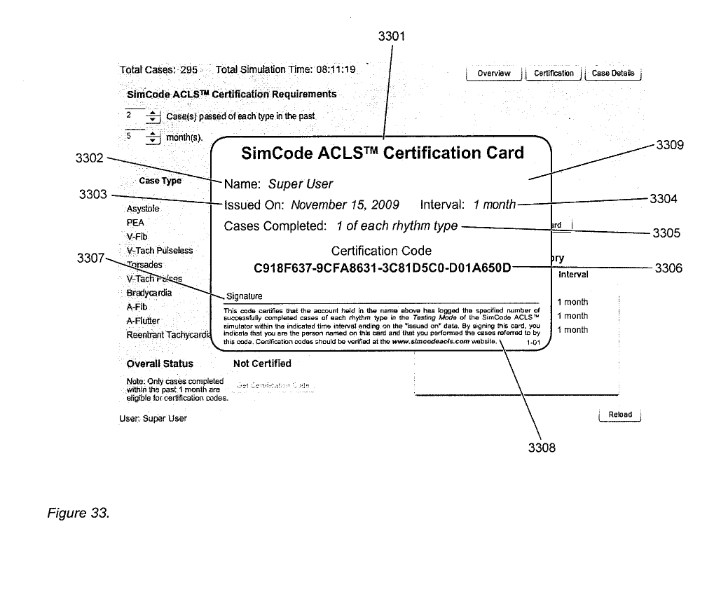

As illustrated in FIG. 33, in one embodiment the Certification panel further provides functionality to generate certification codes and cards. If the user meets chosen certification criteria, the option to generate a certification code will become available. Choosing this option generates a certification code that is stored on the server. This code is integrated into a simulation certification card that can be displayed on this panel. The user then has options to, for example, magnify the view of the certification card or to print it out. The user can also review previously issued certification codes/cards on this panel. These codes can be verified for authenticity and checked for the associated certification parameters on the website.

FIG. 33 illustrates an example screenshot of the Certification panel from the Performance Data Review Module for Users showing a magnified view of a certification card. Item 3301 is an example of a display showing an enlarged view of the certification card. Item 3302 is an example of a display showing the user's name as issued on the certification card. Item 3303 is an example of a display showing the date the particular certification was issued to the user. Item 3304 is an example of a display showing the time period parameter associated with this particular certification. Item 3305 is an example of a display showing the number of each case type completed associated with this particular certification. Item 3306 is an example of a display showing the certification code generated by the server(s) and assigned for this particular certification. Item 3307 is an example of a display showing a place for the user to sign his/her signature on a printed version of the card. Item 3308 is an example of a display showing additional information about the certification. Item 3309 is an example of a display showing additional decorations on the card which can serve various purposes such as but not limited to a watermark, security markings, or other design.

Case Details Panel

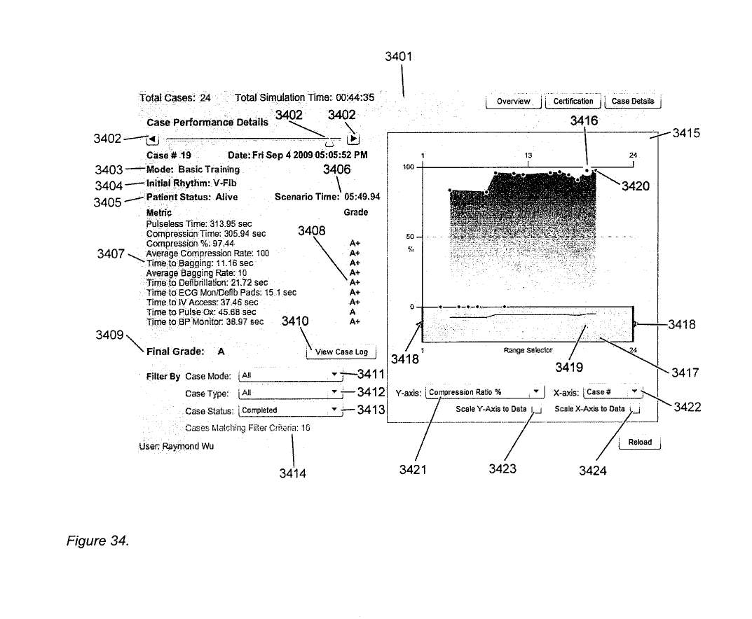

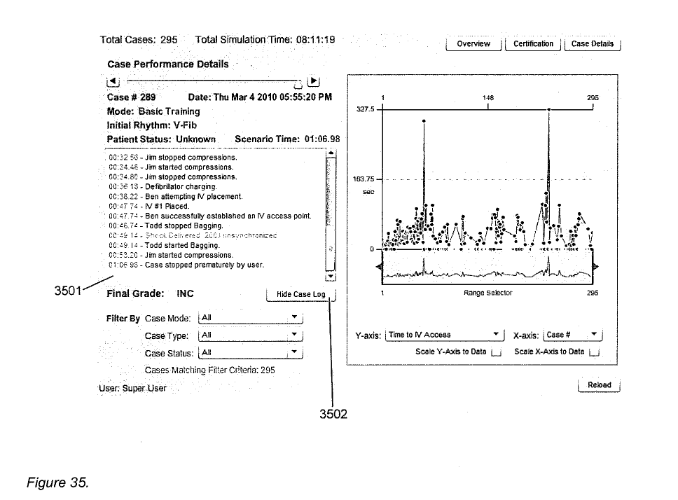

The Case Details panel, illustrated in FIG. 34, provides an interface that allows the user to review the performance data on a case-by-case basis. It contains at least two subpanels. The first subpanel contains an interface to navigate through the selected cases, with the display detailing the actual case performance data. This panel also contains an interface to allow selection of criteria for filtering the list of cases performed by the user (e.g. filter by initial patient rhythm, completed vs. incomplete cases, patient status, etc.) The second subpanel, illustrated in FIG. 34, displays aggregated performance data in a graphical form. An interface allows the user to select which metric is to be displayed on each axis as well as scaling preferences. The current case being displayed on the first subpanel has its corresponding data point highlighted on the second subpanel. Therefore, the user can navigate through the cases using the interface on the first subpanel and quickly see the corresponding data point in the second subpanel. Similarly, the user can click on a data point on the second subpanel and the corresponding case data will be displayed on the first subpanel (see FIG. 34). The saved case logs are also available for review on this panel (see FIG. 35).

FIG. 34 illustrates an example screenshot of the Case Details panel from the Performance Data Review Module for Users showing the grade breakdown from a case. Item 3401 is an example of the Case Details interface. Item 3402 is an example of a set of controls that allows the user to navigate through his/her history of cases quickly. Item 3403 is an example of a display that shows the simulation mode for the selected case being displayed. Item 3404 is an example of a display showing the initial patient rhythm for the selected case being displayed. Item 3405 is an example of a display showing the patient's status at the end of the case for the case being displayed. Item 3406 is an example of a display showing the elapsed simulation time for the case being displayed. Item 3407 is an example of a display showing the metrics recorded during the simulation case being displayed. Item 3408 is an example of a display showing the corresponding grades for the metrics recorded during the simulation case being displayed. Item 3409 is an example of a display showing the final grade for the simulation case being displayed. Item 3410 is an example of a control the user can activate to display the simulation case log. Item 3411 is an example of a control that the user can use to change the case filtering parameters by simulation mode. Item 3412 is an example of a control that the user can use to change the case filtering parameters by initial patient rhythm type. Item 3413 is an example of a control that the user can use to change the case filtering parameters by case ending status. Item 3414 is an example of a display showing the number of cases that matched the selected case filtering parameters. Item 3415 is an example of interface showing a graphical representation of the filtered case data and controls to adjust the graphical representation. Item 3416 is an example of a display indicating the selected case being displayed on the graph data points. Item 3417 is an example of an interface which the user can use to adjust the domain (x-axis) position and window of the data graph. Item 3418 is an example of controls that the user can use, for example by clicking and dragging, to adjust the domain (x-axis) position and window of the data graph. The control on the left indicates the domain position for the left side of the data graph display and the right control indicates the domain position for the right side of the data graph display. The farther apart the two controls are, the larger the domain span that is displayed in the data graph. Item 3419 is an example of a display that indicates where in the interface 3417 that the currently displayed case is located relative to the domain space. Item 3420 is an example of a control which displays a data point on the data graph display and also can be activated by the user to display the case data associated with that data point on the left side of 3401. These data points can be color coded to represent different kinds of data. Also, when the user hovers the mouse over the data point, a display can show the actual numeric value of the data point. Item 3421 is an example of a control which allows the user to change the metric that is being displayed on the data graph display. Item 3422 is an example of a control which allows the user to change the data that is used for the x-axis, for example, such as the case number or the date the case was run. Item 3423 is an example of a control which allows the user to change the scaling mode of the y-axis. For example, one mode could show the data scaled to the entire range of data of all the cases in the user's history. Another mode could show the data scaled to just the range of data that is being displayed (i.e. matches the case filtering parameters). Item 3424 is an example of a control which allows the user to change the scaling mode of the x-axis. For example, one mode could show the data scaled to the entire range of data of all the cases in the user's history. Another mode could show the data scaled to just the range of data that is being displayed (i.e. matches the case filtering parameters).

FIG. 35 illustrates an example screenshot of the Case Details panel from the Performance Data Review Module for Users showing the case event log from a case. Item 3501 is an example of an interface showing the case log for the case currently being displayed. Item 3502 is an example of a control that the user can activate to hide the case log interface and show the display with the case metrics and grades.

Performance Data Review Module for Managers

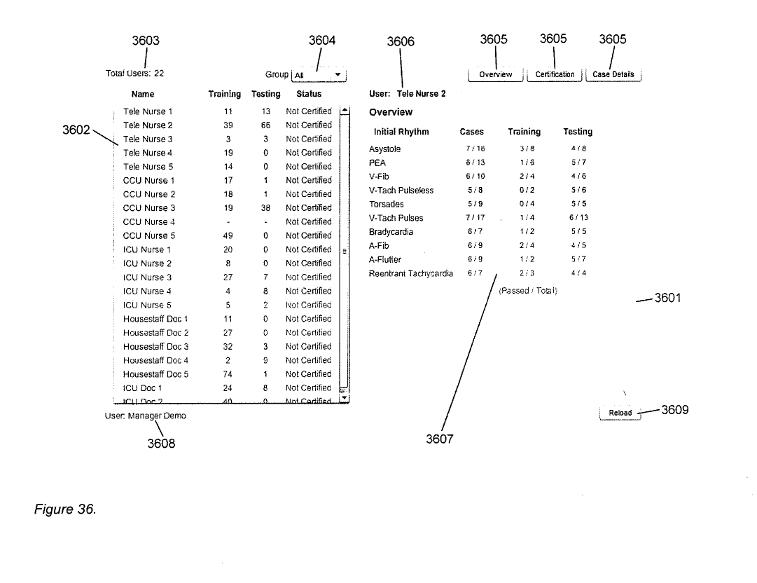

The system also includes a Manager Performance Data Review module, illustrated in FIGS. 36-38, which provides a way for managers of a group of users to access the case performance data acquired by the simulator for each user in the manager's group. The functionality of the module is similar to the User Performance Data Review module described earlier, but with at least a few differences. It contains a user selection interface to allow display and navigation through the users' performance data on a user-by-user basis. It can also display statistics about the number of cases performed and overall certification status for each user based on currently selected certification parameters. Using this interface, the manager can select a user, after which the module will display the case performance data for that user. As with the User Performance Data Review module, this data can be reviewed through one of at least three main panels as detailed below.

Overview Panel

An Overview panel, illustrated in FIG. 36, is similar in functionality to its counterpart in the User Performance Data Review module.

FIG. 36 illustrates an example screenshot of the Overview Panel from the Performance Data Review Module for Managers. Item 3601 is an example of an Overview Panel interface for the Performance Data Review Module for Managers. Item 3602 is an example of an interface through which a manager can quickly see a summary for each user that is under the manager's purview. The summary can include, but is not limited, to information such as cases completed in training and testing modes, as well as certification status based on the currently selected certification parameters. The manager can drill-down and see more detailed information about any particular user by selecting the user's record on this interface through a mouse click, keyboard input, or some other appropriate input mechanism. This interface provides a quick way for managers to view and track the certification status of a large group of users under their purview. Item 3603 is an example of a display which indicates the total number of users under the manager's purview. Item 3604 is an example of a control, such as a drop down menu, which allows the manager to filter the users that are displayed in interface 3602 by group identification numbers. This allows the manager to work with data from users that are part of a particular group, instead of working with the entire set of users all the time. Item 3605 is an example of controls that the user can activate to navigate to other displays in the Performance Data Review Module for Managers. Item 3606 is an example of a display which shows which user's data is currently being drilled-down and displayed in detail. Item 3607 is an example of a display which shows more detailed overview information about a user's completed cases. This display can be similar to the Overview Panel from the Performance Data Review Module for Users illustrated and described in FIG. 31. Item 3608 is an example of a display which can show additional information such as the username of the manager that is currently logged in. Item 3609 is an example of a control that the user can activate to reload and refresh the data that is being viewed with the Performance Data Review Module for Managers.

Certification Panel

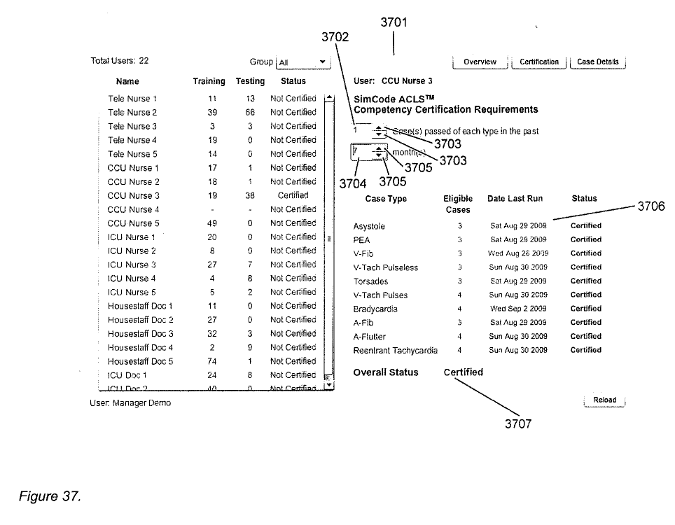

A Certification panel, illustrated in FIG. 37, is similar in functionality to its counterpart in the User Performance Data Review module. In one embodiment, system includes an option (not shown) to generate and review certification codes/cards. In one embodiment, selecting and/or changing certification parameters re-filters and re-analyzes the performance data for all of the users, not just the selected user being currently viewed. The user selection interface then updates the overall certification status for each user automatically, allowing an easy way to check the certification status for all the users based on the newly selected certification parameters.

FIG. 37 illustrates an example screenshot of the Certification panel from the Performance Data Review Module for Managers. Item 3701 is an example of the Certification panel interface on the Performance Data Review Module for Managers. Item 3702 is an example of a display showing the current certification setting for the number of cases of each case type that need to be passed. Item 3703 is an example of controls that the user can use to increase or decrease the number cases of each case type that need to be passed for certification. Item 3704 is an example of a display showing the current certification setting for the most recent time period during which the cases need to be passed to count towards certification. Item 3705 is an example of controls that the user can use to increase or decrease the length of the most recent time period during which the cases need to be passed to count toward certification. Item 3706 is an example of a display that shows information about the cases which match the certification parameters show in item 3702 and item 3704. The information can be categorized by case type (initial patient rhythm type) and can include, but is not limited to, the number of eligible cases, the date the last eligible case was run, and the certification status for that particular case type. This display can be updated whenever certification parameters are changed. 3207 is an example of a display that shows the overall certification status for the selected certification parameters shown in item 3702 and item 3704.

Case Details Panel

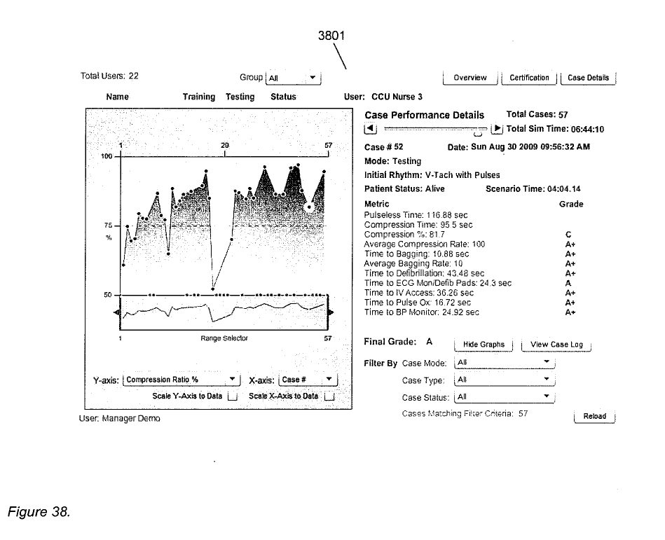

A Case Details panel, illustrated in FIG. 38, is similar in functionality to its counterpart in the User Performance Data Review module. However, there is a button which can be used to toggle on and off the visibility of the subpanel which provides the graphical representation of aggregate data, allowing quick access to the user selection interface underneath it.

FIG. 38 illustrates an example screenshot of the Case Details panel from the Performance Data Review Module for Managers showing the grade breakdown from a case. Item 3801 is an example of the Case Details panel interface for the Performance Data Review Module for Managers. It can be similar to the Case Details panel illustrated and described in FIGS. 34 and 35.

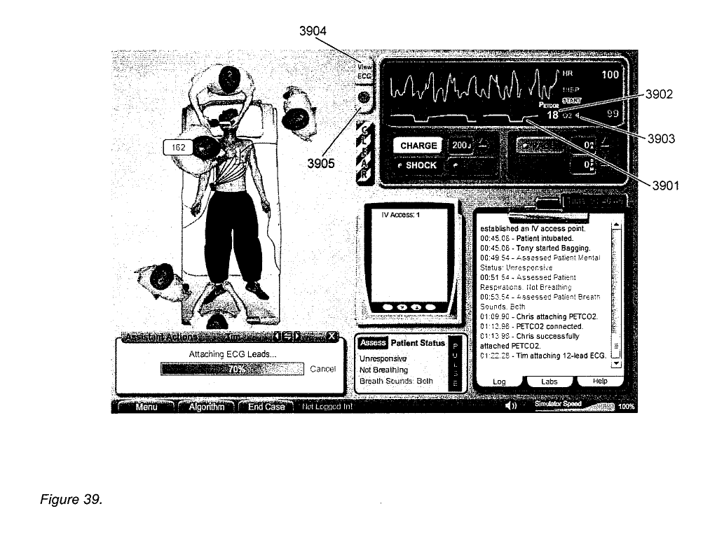

Referring to FIG. 39, quantitative capnography tracings and end-tidal carbon dioxide partial pressure readings can also be viewed by having the appropriate monitor connected by an assistant. These tracings and readings can include auditory feedback to the user as well, such as, but not limited to tones of various pitches, alarms, and voices.

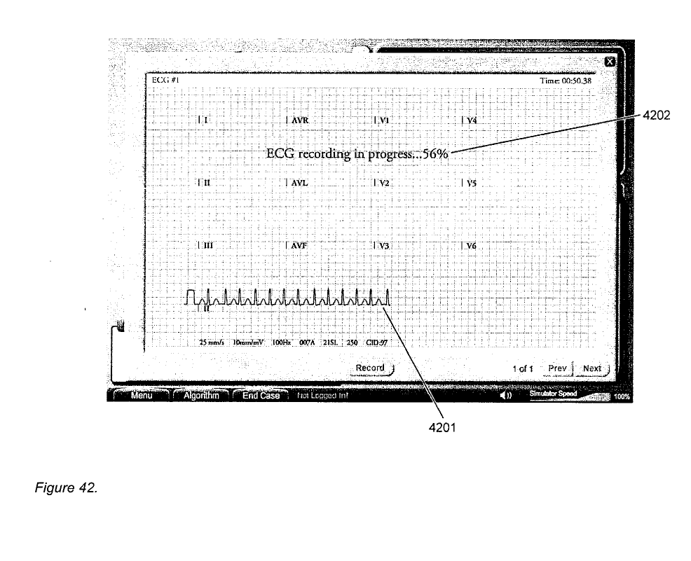

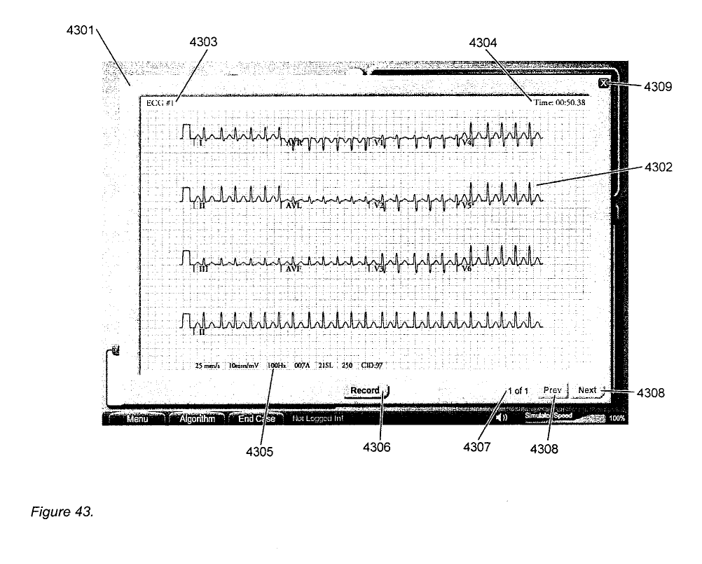

Referring to FIG. 39, a set of controls, such as a pair of buttons, allows the user to record new 12-lead ECG tracings from the patient and view any previously recorded 12-lead ECG tracings. Activating the control which starts a new 12-lead ECG recording can start the recording in a background process. Activating the control to view previously recorded 12-lead ECG tracings can show a panel with the tracing in it as illustrated in FIG. 43. The panel can also have controls on it to allow the user to navigate between different tracings and to record new tracings as illustrated in FIG. 42. The 12-lead ECG tracings are also calculated in real-time on a frame-by-frame basis based on the patient's physiology model as well as interventions being performed on the patient.

The quantitative capnography tracing and end-tidal carbon dioxide partial pressure reading is calculated in real-time on a frame-by-frame basis based on the state of the patient's physiology model as well as interventions being performed on the patient. These tracings and readings are also affected by the quality of the interventions being performed, such as, for example, the rate and depth of the chest compressions being delivered and rate of ventilation.

FIG. 39 illustrates an example screenshot of the quantitiative capnography tracing 3901 and the end-tidal carbon dioxide partial pressure readings 3902. Also shown is an example of a control 3903 that the user can activate to turn on or off the audio feedback from the Pulse Oximeter. Item 3904 is an example of a control that the user can activate to show the 12-lead ECG recording and display interface. Item 3905 is an example of a control that the user can activate to begin recording of a new 12-lead ECG tracing. In one embodiment, the recording will be performed but does not need to be displayed as it is recording. In this way, it acts almost like a “remote control” for the 12-lead ECG recording device.

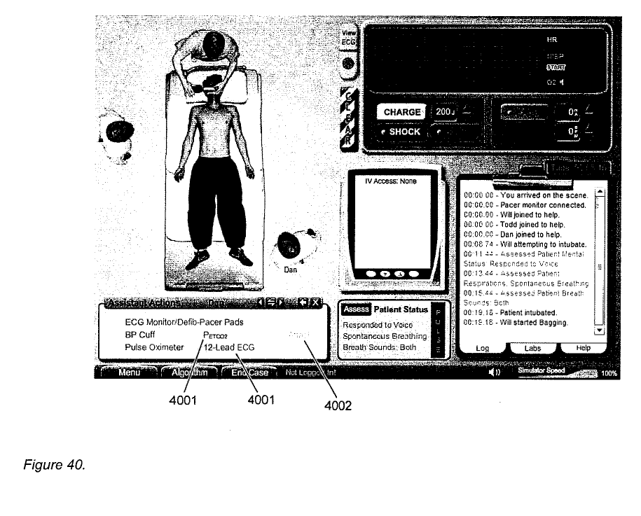

FIG. 40 illustrates another example screenshot of the Attach Monitors Submenu options. Item 4001 is another example of controls which the user can activate to select different monitors to be setup and attached to the patient by the currently selected assistant. Item 4002 is another example of a control which the user can activate to confirm the selected option and have the assistant begin performing the selected option.

FIG. 41 illustrates an example screenshot of the “tracings” display which also depicts the quantitative capnography tracings from the simulation. Item 4101 is an example of a display which shows quantitative capnography tracings recorded during the simulation.

FIG. 42 illustrates an example screenshot of the 12-lead ECG display panel showing a 12-lead ECG being recorded. Item 4201 is an example of a display showing a 12-lead ECG tracing in progress. Item 4202 is an example of a display showing a numeric indicator of the progress of the 12-lead ECG tracing.

FIG. 43 illustrates an example of a previously recorded 12-lead ECG being displayed. Item 4301 is an example of an interface that allows the user to navigate through and view recorded 12-lead ECG tracings as well as record new tracings. Item 4302 is an example of a display showing a 12-lead ECG tracing. Item 4303 is an example of a display showing the identification number for the 12-lead ECG tracing being displayed. Item 4304 is an example of a display showing the simulation time stamp when the displayed 12-lead ECG tracing was recorded. Item 4305 is an example of a display showing additional information about the 12-lead ECG tracing being displayed. Item 4306 is an example of a control that the user can activate to start a new 12-lead ECG recording. Item 4307 is an example of a display which indicates which 12-lead ECG tracing is being displayed out of the total number of 12-lead ECG tracings that are available for viewing. Item 4308 is an example of controls that allow the user to navigate through the collection of 12-lead ECG tracings that are available for viewing. Item 4309 is an example of a control that the user can activate to hide the interface 4301.

FIG. 44 illustrates another example screenshot of the Overview Panel from the Performance Data Review Module for Users showing the Performance Index History and Graph. Item 4401 is an example of a display showing a graph of the cumulative Performance Index History over time. Item 4402 is an example of a display showing the numeric value of the current cumulative Performance Index. Item 4403 is an example of another control that the user can activate to navigate between different panels in the Performance Data Review Module for Users.

Website/Server-Interface

The system also includes a website providing the mechanisms for the other three components to interact by transferring, processing, and storing data. In one embodiment, the simulator and the two performance data review modules reside on the website's server where users and managers can access them through password protected accounts. When the user loads and uses the simulator, data is transferred between the simulator and data server to provide details for generating simulations and to store performance data. The performance data review modules allow access to the stored case data on the server.

Alternatively, the system can further include guided interactive tutorials to further facilitate the learning process for novices. In one embodiment, such a system could provide prompts with information about the selected simulation scenario and how to proceed at each stage of the scenario. In one embodiment, when the novice completes one of the interactive tutorials, the novice can immediately practice on the training modes, allowing an opportunity to quickly consolidate what was just learned. As knowledge and confidence improves, the novice can move on to the more advanced training mode and finally on to the testing mode to accumulate credits for certification.

In one embodiment, the system of the present invention can further include a score board, which allows individuals to compete against each other for higher scores. This further aspect can be used, for example, for entertainment, or can be extended to education related competitions between groups of people (e.g. residency programs) or even regional, national, or international competitions. This could help promote the regular review and practice of ACLS skills.

Even further, in one embodiment, this system can be adapted to train people in other kinds of resuscitation skills, such as, but not limited to, Pediatric Advanced Life Support and Advanced Trauma Life Support. In addition, this system can also be adapted to train people in scenarios which may be less urgent, such as, but not limited to, Acute Coronary Syndrome, Myocardial Infarction, Cerebral Vascular Accidents or Strokes, Gastro-Intestinal Bleeds, and Sepsis. This system can also be adapted to train people in scenarios that have the potential to become urgent or alternatively, may never become urgent. For example, it could be used to train people in anesthesia scenarios or other in-hospital scenarios. It could also be used to train people in outpatient scenarios or out-of-hospital scenarios. In one embodiment, this system can be adapted to train people in scenarios which may include more than one patient, or even no patient at all. For example, a bioterrorism event or threat could illustrate a scenario where there are many patients, or no patients at all. Users would be trained on how to respond to various situations.

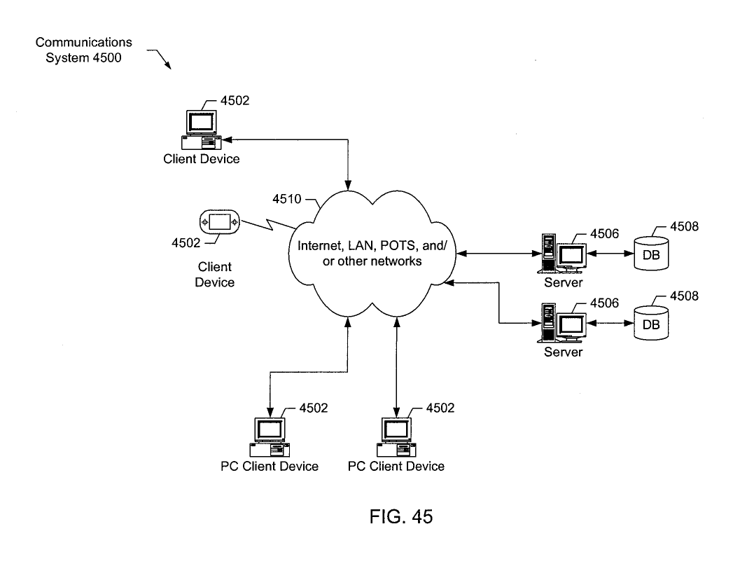

The present process and system can be realized in a device employing a non-web based computer program, but can also be readily realized in a device employed in a network communications system. A high level block diagram of an exemplary network communications system 4500 is illustrated in FIG. 45. Illustrated system 4500 includes one or more client devices 4502, one or more web servers 4506, and one or more databases 4508. Each of these devices may communicate with each other via a connection to one or more communications channels 4510 such as the Internet or some other wired and/or wireless data network, including, but not limited to, any suitable wide area network or local area network. As stated above, it will be appreciated that any of the devices described herein may be directly connected to each other instead of over a network.

For devices 4502 employed in network communications system 4500, web server 4506 stores a plurality of files, programs, and/or web pages in one or more databases 4508 for use by client devices 4502 as described in detail below. Database 4508 may be connected directly to the web server 4506 and/or via one or more network connections. Database 4508 stores data as described in detail below.

One web server 4506 may interact with a large number of client devices 4502. Accordingly, each server 4506 is typically a high end computer with a large storage capacity, one or more fast microprocessors, and one or more high speed network connections. Conversely, relative to a typical server 4506, each client device 4502 typically includes less storage capacity, a single microprocessor, and a single network connection.

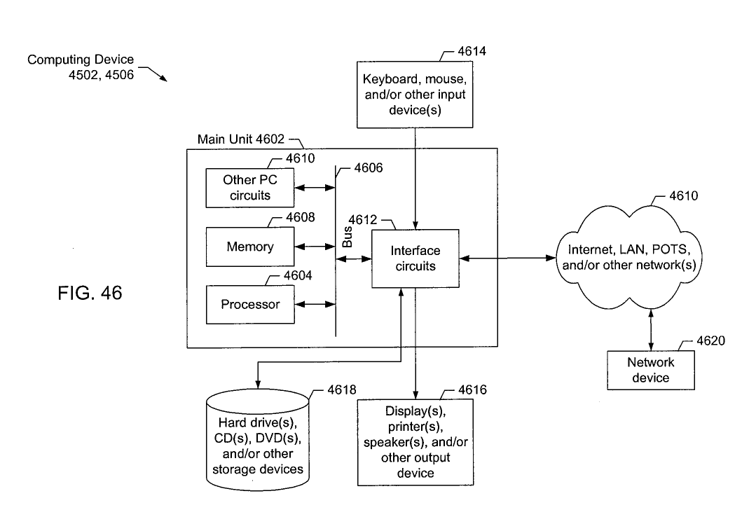

A more detailed block diagram of the electrical systems of a computing device (e.g., client device 4502 and/or server 4506) is illustrated in FIG. 46. Although the electrical systems of a client device 4502 and a typical server 4506 may be similar, the structural difference between the two types of devices are well known.

Client device 4502 may include a personal computer (PC), desktop computer, a tablet computer, a personal digital assistant (PDA), an Internet appliance, a cellular telephone, a smartphone, or any other suitable communication device. Client device 4502 may also be a stand alone device capable of docking with one of the above communication devices such as a personal computer.

Client device 4502 includes a main unit 4602 which preferably includes one or more processors 4604 electrically coupled by an address/data bus 4606 to one or more memory devices 4608, other computer circuitry 4610, and one or more interface circuits 4612. Processor 4604 may be any suitable processor. Memory 4608 preferably includes volatile memory and non-volatile memory. Preferably, memory 4608 stores a software program that executes a process such as the example described below and illustrated in the flowchart of FIG. 6. This program may be executed by Processor 4604 in any suitable manner. Memory 4608 may also store digital data indicative of documents, files, programs, web pages, etc. retrieved from server 4506 and/or loaded via an input device 4614, as well as output data from processor 4604 after executing the software program.

Interface circuit 4612 may be implemented using any suitable interface standard, such as an Ethernet interface and/or a Universal Serial Bus (USB) interface. One or more input devices 4614 may be connected to interface circuit 4612 for entering data and commands into main unit 4602. For example, input device 4614 may be a keyboard, mouse, touch screen, track pad, track ball, isopoint, and/or a voice recognition system.

One or more displays, printers, speakers, and/or other output devices 4616 may also be connected to main unit 4602 via interface circuit 4612. Display 4616 may be a cathode ray tube (CRTs), liquid crystal displays (LCDs), or any other type of display. Display 4616 generates visual displays of data generated during operation of client device 4402. For example, display 4616 may be used to display web pages received from server 4506, output data received from processor 4604. The visual displays may include prompts for user input, calculated values, data, etc.

One or more storage devices 4618 may also be connected to main unit 4602 via interface circuit 4612. For example, a hard drive, CD drive, DVD drive, and/or other storage devices may be connected to main unit 4602. Storage devices 4618 may store any type of data used by client device 4502.

Client device 4502 may also exchange data with other network devices 4620 via a connection to network 4510. The network connection may be any type of network connection, such as an Ethernet connection, digital subscriber line (DSL), telephone line, coaxial cable, etc. Alternatively, the network connection may be wireless. Users 4514 of the system 4500 may be required to register with the server 4506. In such an instance, each user 4514 may choose a user identifier (e.g., e-mail address) and a password which may be required for the activation of services. The user identifier and password may be passed across the network 4510 using encryption built into the user's browser. Alternatively, the user identifier and/or password may be assigned by the server 4506.

In summary, persons of ordinary skill in the art will readily appreciate that methods and apparatus for patient resuscitation simulation training and performance tracking have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

The invention is claimed as follows:

1. A method of simulating a patient resuscitation in an environment, the method comprising:
generating a graphical simulation including representations of a patient, at least one assistant, and medical resuscitation equipment;
selecting a simulation mode;
selecting an initial patient rhythm;
calculating a model of the physiology of the patient;
calculating a model of the environment;
monitoring user performance metrics;
determining a status of the patient; and
generating a debriefing.

2. The method of claim 1, further including simulating calculating a pulse of the patient by specifying any one of a plurality of pulse points on the representation of the patient and generating an impulse that is based on (i) the strength of a specified pulse point and (ii) the model of the physiology of the patient.

3. The method of claim 2, wherein the pulse points are not visually depicted on the representation of the patient.

4. The method of claim 3, wherein the impulse is associated with feedback to a user, the feedback including any one of (i) tactile feedback; (ii) kinesthetic feedback; and (iii) haptic feedback.

5. A computer readable medium storing instructions for simulating a patient resuscitation in an environment, the instructions causing a computing device to:
generate a graphical simulation including representations of a patient, at least one assistant, and medical resuscitation equipment;
select a simulation mode;
select an initial patient rhythm;
calculate a model of the physiology of the patient;
calculate a model of the environment;
monitor user performance metrics;
determine a status of the patient; and
generate a debriefing.

6. The computer readable medium of claim 6, further including simulating calculating a pulse of the patient by specifying any one of a plurality of pulse points on the representation of the patient and generating an impulse that is based on (i) the strength of a specified pulse point and (ii) the model of the physiology of the patient.

7. The computer readable medium of claim 7, wherein the pulse points are not visually depicted on the representation of the patient.

8. The computer readable medium of claim 8, wherein the impulse is associated with feedback to a user, the feedback including any one of (i) tactile feedback; (ii) kinesthetic feedback; and (iii) haptic feedback.

9. A system for simulating a patient resuscitation in an environment comprising a processor structured to cause the system to:
generate a graphical simulation including representations of a patient, at least one assistant, and medical resuscitation equipment;
select a simulation mode;
select an initial patient rhythm;
calculate a model of the physiology of the patient;
calculate a model of the environment;
monitor user performance metrics;
determine a status of the patient; and
generate a debriefing.

10. The system of claim 9, further including simulating calculating a pulse of the patient by specifying any one of a plurality of pulse points on the representation of the patient and generating an impulse that is based on (i) the strength of a specified pulse point and (ii) the model of the physiology of the patient.

11. The system of claim 10, wherein the pulse points are not visually depicted on the representation of the patient.

12. The system of claim 11, wherein the impulse is associated with feedback to a user, the feedback including any one of (i) tactile feedback; (ii) kinesthetic feedback; and (iii) haptic feedback.
